(19) United States
(12) Patent Application Publication
(10) Pub. No.: US 2026/0327505 A1
(43) Pub. Date: Oct. 22, 2026

(54) SYSTEMS AND METHODS FOR PROVIDING SUSTAINABLE HYDROCARBON FUELS AND MATERIALS

(71) Applicant: Universal Fuel Technologies, Inc., Los Altos, CA (US)

(72) Inventors: Alexei Beltyukov, Los Altos Hills, CA (US); Denis Pchelintsev, Santa Cruz, CA (US); Dmitry Shalupkin, Gianyar (ID); Stephen Sims, Houston, TX (US); Artem Ublik, Alanya/Antalya (TR)

(73) Assignee: Universal Fuel Technologies, Inc., Los Altos, CA (US)

(21) Appl. No.: 19/221,849

(22) Filed: May 29, 2025

Related U.S. Application Data
(60) Provisional application No. 63/652,814, filed on May 29, 2024.

(51) Int. Cl. C10G 65/04; C10G 3/00; C10G 7/04

(52) U.S. Cl. CPC C10G 65/046; C10G 3/50; C10G 7/04; C10G 2300/1088; C10G 2400/30

(57) ABSTRACT

There are provided systems and methods for producing hydrocarbon end products from conventional, renewable or synthetic hydrocarbon feed stocks. These hydrocarbon end products would include sustainable aviation fuel (SAF). These systems and methods can use renewable alcohols, such as ethanol, as the starting material. There is provided an unblended sustainable aviation fuel (SAF) having at least 8% aromatics and a method of making this unblended. This SAF can be made entirely from renewable feed stocks.

This application: claims under 35 U.S.C. § 119 (e) (1) the benefit of the filing date of, and claims the benefit of priority to, U.S. provisional application Ser. No. 63/652,814 filed May 29, 2024, the entire disclosure of which is incorporated herein by reference.

### BACKGROUND OF THE INVENTION

### Field of the Invention

The present inventions relate to new and improved methods, devices and systems for recovering and converting starting materials, such as LPG, ethers, naphthas, alcohols, and light olefins, into useful and economically viable materials, including such materials that are environmentally friendly materials.

As used herein, unless specified otherwise, the term “naphtha” should be given its broadest possible meaning and would include a refined, partly refined, or unrefined hydrocarbon product produced by the distillation or chemical conversion of a source material, including one of more of hydrocarbons, fuel gas, alcohols, ethers (e.g., petroleum, natural gas, biomass, waste oil, FOG (fats, oils and/or grease)), and includes renewable naphtha, and petroleum naphtha. Naphtha consists of mixture of several types of hydrocarbons including paraffins, olefins, naphthenes (also known as cycloparaffins or cycloalkanes) aromatics with paraffins having the general formula CₙH₂ₙ₊₂ (where n is the “carbon number” and n=5~12). The carbon numbers for naphtha are generally in the range of C5 to C12, and boiling points generally in the range of approximately 38° C. to 200° C. (100° F. to 392° F.) and predominantly in the range of 90° C. to 180° C. (194° F. to 356° F.). Heavier naphthas, having carbon numbers from about 9 to 12 can have high boiling points up to about 200° C. (392° F.). Naphthas would include naphthas obtained by any process, including F-T (Fischer Tropsch) and HEFA (hydrogenated esters and fatty acids) Naphthas.

A typical naphtha, can include both petroleum naphtha and renewable naphtha. A typical naphtha can be a mixture of hydrocarbons generally within the gasoline boiling range (the initial boiling point is not generally standardized; the end boiling temperature (i.e, temperature where the last of the liquid becomes a vapor) is not more than 215° C.). In particular, the end boiling point may be 200° C., 180° C., 160° C. or 85° C. Preferably, the end boiling point is not higher than 180° C. The onset of boiling may be, for example, 62° C., 85° C., 140° C. Preferably, the initial boiling point is not lower than 62° C.

The term naphtha includes the material identified as CAS Registry Number 8030-30-6.

As used herein, unless specified otherwise, the term “naphthene” means a saturated hydrocarbon that has at least one ring of carbon atoms and has the general formula of CₙH₂ₙ.

As used herein, unless specified otherwise, the terms “renewable naphtha” and “naphtha from renewable source” and naphtha produced via synthesized hydrocarbon route such as syngas from hydrogen and CO₂ and similar such terms, should be given their broadest possible meaning and would include any naphtha that is derived (i.e., obtained from a starting material) in part, and preferably in whole, from a renewable hydrocarbon source, such as vegetable and grain oils (e.g., corn, sun flower, soybean, canola), fatty acids and esters, algae, municipal wastes, waste water treatment sludge, biomass (including agriculture and forestry waste as well as on purpose grown biomass), animal fats, and FOG (cooking fats, oils and grease)).

As used herein, unless specified otherwise, the terms “synthesized”, “synthesized hydrocarbon” and “synthetic hydrocarbon” means materials and hydrocarbons that are obtained from a starting material other than a traditional geological hydrocarbon resource, e.g., crude oil, natural gas liquid condensates, heavy oil, shale oil, tar sands and oil sands. Synthesized hydrocarbons include hydrocarbons that are derived (i.e., obtained from a starting material), in part, and preferably in whole, from materials such as, vegetable and grain oils (e.g., corn, sun flower, soybean, canola), fatty acids and esters, algae, municipal wastes, waste water treatment sludge, biomass, animal fats, alcohols, ethers, CO₂, and FOG. Synthesized hydrocarbons include renewable hydrocarbons, including renewable naphtha. Hydrocarbons derived from natural gas (i.e., methane) are considered synthesized hydrocarbons for the purpose of this Specification. Hydrocarbons derived from flare gas, although not typically grouped with synthesized hydrocarbons, are considered synthesized hydrocarbons for the purpose of this Specification. Liquid hydrocarbons derived from CPC, coke and coal are typically grouped with synthesized hydrocarbons, are considered synthesized hydrocarbons for the purpose of this Specification.

As used herein, unless specified otherwise, the terms “calcined petroleum coke,” “CPC” and similar such terms, should be given its broadest possible meaning and would include any coke that is prepared using, or subject to, a calcining process, e.g., high temperature processing in a kiln or similar apparatus under a controlled atmosphere, typically reduced, low, O₂ atmosphere.

As used herein, unless specified otherwise, the terms “sustainable aviation fuel,” and “SAF,” should be given their broadest possible meaning and would include aviation fuel for jet engines and turbine engines, that is obtained at least in part, and preferably in whole, from a renewable hydrocarbon source, such as vegetable and grain oils (e.g., corn, sun flower, soybean, canola), algae, municipal wastes, waste water treatment sludge, biomass, animal fats, CO₂, alcohols, ethers, FOG (cooking fats, oils and grease) and waste gases). SAF includes renewable jet fuel, bio jet fuel, and sustainable alternative jet fuel and sustainable aviation kerosine. A preferred SAF is an equivalent to, i.e., “drop in” replacement for, commercially available jet fuels, such as Jet A1 or Jet A fuel (which are well known in the aviation arts and defined by ASTM D 1655 (2023), which is incorporated herein by reference. By “drop in” replacement, it is meant that the SAF is entirely fungible with conventional kerosene requiring no adaptation of the jet engines or the associated fuel delivery equipment and infrastructure. Fact Sheet 2, Sustainable Aviation Fuel: Technology Certification, International Air Transport Association (IATA) (2024), which is incorporated herein by reference, provides further examples, characteristics and properties of SAFs.

As used herein, unless specified otherwise, the terms “renewable” and “renewable hydrocarbon” and similar such terms, is to be given it broadest possible meaning and would include materials and hydrocarbons that are produced via synthesized hydrocarbon route such as syngas from hydrogen and CO₂, and would include hydrocarbons that are derived (i.e., obtained from a starting material) in part, and preferably in whole, from a renewable hydrocarbon source, such as vegetable and grain oils (e.g., corn, sun flower, soybean, canola), fatty acids and esters, algae, municipal wastes, waste water treatment sludge, biomass (including agriculture and forestry waste as well as on purpose grown biomass), animal fats, and FOG (cooking fats, oils and grease)). Renewable hydrocarbons would include “sustainable” and “sustainable hydrocarbons” and similar such terms.

As used herein, unless specified otherwise, the term “conventional hydrocarbon,” “fossil based hydrocarbon” and similar such terms, means hydrocarbons derived from traditional geological hydrocarbon resources, such as: crude oil, natural gas liquid condensates, heavy oil, shale oil, and oil sands. For the purposes of this Specification flare gas and natural gas (i.e., methane) would not be considered a conventional hydrocarbon.

As used herein, unless specified otherwise, the terms “conventional jet fuel,” “petroleum based jet fuels,” and “fossil based jet fuels” and similar such terms refer to jet fuel that is solely a conventional hydrocarbon, or derived from conventional hydrocarbon starting materials. Such fuels, include Jet A1 or Jet A fuel.

As used herein, unless specified otherwise, the terms “synthesized iso-paraffin,” “synthetic iso-paraffin” and “SIP,” mean a synthetic hydrocarbon that is comprised essentially of iso-paraffins. Paraffins are Cₙ H₂ₙ₊₂, which can be distinguished from olefins and naphthenes which are CₙH₂ₙ.

As used herein, unless specified otherwise, the terms “synthesized paraffinic kerosine,” “synthetic paraffinic kerosine” and “SPK,” mean a synthetic hydrocarbon that is comprised essentially of iso-paraffins, normal paraffins and cycloparaffins.

As used herein, unless specified otherwise the term “SKA” means synthesized kerosene with aromatics.

As used herein, unless specified otherwise, the terms “alcohol-to-jet synthetic kerosene with aromatics” and “ATJ-SKA” mean a hydrocarbon derived from alcohol that is produced by an initial dehydration followed by a bifurcated production stream, with one stream consisting of oligomerization, hydrogenation and fractionation and the other consisting of aromatization and fractionation, and with both streams then blended together to from the ATJ-SKA.

As used herein, unless specified otherwise, the terms “alcohol-to-jet cycloalkanes with aromatics” and “ATJ-CKA” mean a hydrocarbon derived from alcohol that is produced by dehydration (applicable only to alcohol starting material), oligomerization and dehydrocyclization, hydrogenation, and fractionation.

As used herein, unless specified otherwise, the terms “naphtha and alcohol-to-jet synthesis aromatic kerosene” and “NETJ-SAK” mean a hydrocarbon derived from a mix of renewable naphtha and alcohol that is produced by dehydration (applicable only to alcohol), oligomerization and dehydrocyclization, alkylation and fractionation.

As used herein, unless specified otherwise, the terms “alcohol-to-jet synthetic paraffinic kerosene” and “ATJ-SPK” mean an SPK produced starting from alcohol or olefin and processed through the following steps: dehydration (applicable only to alcohol starting material), oligomerization, hydrogenation, and fractionation.

As used herein, unless specified otherwise, the terms “Fischer-Tropsch” and “FT” generally refer to systems and methods and products using a series of well-known reactions for the conversion of syngas into liquid hydrocarbons. One of the reactions for this process is:

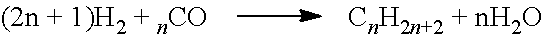

As used herein, unless specified otherwise, the terms “Fischer-Tropsch Synthetic Paraffinic Kerosene” and “FT-SPK” generally refer to systems methods and products that are generally based upon a biomass feed stock that is converted to syngas using gasification, then a Fischer-Tropsch (FT) synthesis reaction converts the syngas to jet fuel. Feedstocks include various sources of renewable biomass, primarily biomass such as municipal solid waste, agricultural wastes, forest wastes, wood, and energy crops.

As used herein, unless specified otherwise, the terms “Hydroprocessed Esters and Fatty Acids” and “HEFA-SPK” generally refer to systems, methods and products that are generally based upon triglyceride feedstocks such as plant oil; animal oil; yellow or brown greases; or waste fat, oil, and greases that are hydroprocessed to break apart the long chain of fatty acids, followed by hydroisomerization and hydrocracking.

As used herein, unless specified otherwise, the terms “Hydroprocessed Fermented Sugars to Synthetic Isoparaffins” and “HFS-SIP” generally refer to systems, methods and products that are generally based upon microbial conversion of sugars to hydrocarbons. Feedstocks include cellulosic biomass feedstocks (e.g., herbaceous biomass and corn stover). Pretreated waste fat, oil, and greases also can be eligible feedstocks.

As used herein, unless specified otherwise, the terms “FT-SPK with Aromatics” and “FT-SPK/A” generally refer to systems, methods and products that are generally based upon a biomass fuel source that is converted to syngas, which is then converted to synthetic paraffinic kerosene and aromatics by FT synthesis. This process is similar to FT-SPK, but with the addition of aromatic components.

As used herein, unless specified otherwise, the terms “Catalytic Hydrothermolysis Synthesized Kerosene,” “CH-SK” and “CHJ” generally refer to systems, methods and products that are generally based upon a clean free fatty acid oil from processing waste oils or energy oils as a fuel source, which is combined with preheated feed water and then passed to a catalytic hydrothermolysis reactor. Feedstocks for the CH-SPK process can be a variety of triglyceride-based feedstocks such as soybean oil, jatropha oil, camelina oil, carinata oil, and tung oil.

As used herein, unless specified otherwise, the terms “Hydrocarbon-Hydroprocessed” and “HC-HEFA-SPK” generally refer to systems, methods and products that are generally based upon the conversion of the triglyceride oil fuel source that was derived from Botryococcus braunii, into jet fuel and other fractionations. Botryococcus braunii is a high-growth alga that produces triglyceride oil.

As used herein, unless specified otherwise, the terms “liquid petroleum gas” and “LPG” mean a gas having a mixture of C4 and C5 hydrocarbons, trace amounts of other hydrocarbons and materials may also be present.

The term “flare gas” and similar such terms should be given their broadest possible meaning, and would include gas generated, created, associated or produced by, or from, oil and gas production, hydrocarbon wells (including, conventional and unconventional wells), petrochemical processing, refining, landfills, waste water treatment, dairies, livestock production, and other municipal, chemical and industrial processes. Thus, for example, flare gas would include stranded gas, associated gas, landfill gas, vented gas, biogas, digester gas, small-pocket gas, and remote gas. For the purposes of this specification the use of flare gas (even if obtained from an oil or gas well) in the present methods, equipment and systems as one of the source materials to make naphtha, and then further to make aviation fuel, would be considered a renewable naphtha to the extent the original feedstock or source of the flare gas is considered renewable, and a sustainable aviation fuel, respectively.

As used herein unless specified otherwise, the terms “syngas” and “synthesis gas” and similar such terms should be given their broadest possible meaning and would include gases having as their primary components a mixture of H₂ and CO; and may also contain CO₂, N₂, and water, as well as, small amounts of other materials.

As used herein, unless specified otherwise, the term “product gas” and similar such terms should be given their broadest possible meaning and would include gasses having H₂, CO and other hydrocarbons, and typically significant amounts of other hydrocarbons, such as methane.

As used herein, unless specified otherwise, the term “unblended” means either an SAF that does not require blending with other components in order to be used in an aircraft engine or an SAF component that requires such blending, prior to the blending.

As used herein, unless specified otherwise, the term “reprocessed gas” includes “syngas”, “synthesis gas” and “product gas”.

As used herein, unless specified otherwise, the terms “aromatics”, “aromatic hydrocarbon” and “arenes” and similar such terms should be given their broadest possible meaning and would include organic compounds having a chemistry typified by benzene, the presences of a 6 carbon member ring, a cyclically conjugated compound, and a cyclic compound that meets Hückel's Rule. These terms would include benzene derivatives and non-benzoids.

As used herein, unless specified otherwise, the use of carbon number terms and nomenclature, such as Cn where “n” is a number, means a hydrocarbon having n carbons, when “n” has a plus or minus sign this means n and more, and n and less respectively carbon atoms are present in the hydrocarbon. Thus, for example C3 means a hydrocarbon with three carbons, C3+ means a hydrocarbon with three or more carbons, and C3-means a hydrocarbon with three or less carbons. Ranges, e.g., C4-C7, and bends and mixtures, e.g., C3/C4, can also be shown using this nomenclature.

As used herein, unless specified otherwise, the terms % and wt % are used interchangeably and refer to the weight of a first component as a percentage of the weight of the total, e.g., formulation, mixture, material or product.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

Generally, the term “about” as used herein unless stated otherwise is meant to encompass the greater of a variance or range of ±10% or the experimental or instrument error associated with obtaining the stated value.

As used herein, unless stated otherwise, room temperature is 25° C., and standard temperature and pressure is 0° C. and 1 atmosphere (1.01325 bar). Unless stated otherwise, and to the extent applicable, material properties (e.g., boiling point), are at standard temperature, pressure, and pressure and temperature.

### SUMMARY

There has been a long-standing, expanding and unmet need, for systems, devices, methods that provide renewable fuels and renewable chemicals, as well as, such fuels, materials and chemicals themselves. For all practical purposes for the foreseeable future transportation systems, such as air planes, and other devices that use combustion engines, such as internal combustion engines and jet turbine engines, will require hydrocarbon-based fuels. Similarly, for all practical purposes for the foreseeable future industries, (chemical, consumer products, automotive, etc.) will require and need hydrocarbon-based materials and chemicals. Prior to the present inventions these hydrocarbon-based materials, fuels and chemicals, were typically derived from conventional hydrocarbon sources. Thus, there is a long standing and increasing need to replace conventional hydrocarbon-based fuels, conventional hydrocarbon-based materials and conventional hydrocarbon-based chemicals with renewable hydrocarbon-based fuels, renewable hydrocarbon-based materials and renewable hydrocarbon-based chemicals.

For example, aviation internal combustion engines and jet turbine engines, for the foreseeable future will require hydrocarbon-based fuels. With this pragmatic acceptance that hydrocarbon-based fuels will be required, and needed for the foreseeable future, there comes increasing regulatory, political and public pressure to have such fuels coming in part, and preferrable in whole, from renewable hydrocarbon sources.

The need for renewable hydrocarbon-based fuel sources, and in particular, for renewable aviation hydrocarbon-based fuel sources, has been largely unmet and is increasing. For example, there has been a long-standing and largely unmet need for drop-in renewable aviation hydrocarbon-based fuel sources, and in particular a drop-in sustainable aviation fuel (“SAF”) that does not require blending with a conventional jet fuel. To date, it is believed that the vast majority of all SAFs are required to be blended with conventional jet fuel in order to be safely used in an aircraft and to meet regulatory approval, and are therefore known as Synthetic Blending Components (SBCs). To date, it is believed that all HEFA-SPK are required to be blended, and this HEFA-SPK SBC represents nearly the entirety of SAF produced today. Thus, synthetic and sustainable hydrocarbons obtained from or constituting, for example, SIP, SPK, ATJ-SKA, ATJ-CKA, ATJ-SPK, FT, FT-SPK, HEFA-SPK, HFS-SIP, FT-SPK/A, CH-SK, HC-HEFA-SPK, NETJ-SAK, and the like, are SBCs and as such must be blended with conventional jet fuel in order to meet safety and regulatory requirements. There are also maximum amounts, i.e., blend limits, for how much of the synthetic and sustainable hydrocarbons can be used, i.e., blended, with the convention jet fuel. (These percentages and blend limits are based upon volume percent-synthetic and sustainable hydrocarbon or SAF to total SAF and convention jet fuel. These percentages and blending limitations do not consider fuel additives, that are generally used in very small amounts.) (Thus, for example, a 50% blend of SAF would mean 1 liter of SAF, mixed with 1 liter of conventional jet fuel—, 1 liter SAF/2 total liters fuel=50% SAF Blend) Thus, FT-SPK, HEFA-SPK, FT-SPK/A, ATJ-SKA and CH-SK have a blend limit of 50%, while the other synthetic and sustainable hydrocarbons have lower, e.g., 30%, 10%, 5%, blend limits.

Embodiments of the present inventions overcome this long-standing problem of blend limits, by providing a synthetic and sustainable hydrocarbon, e.g., an SAF, that can, safely and effectively be used as aviation fuel, having 50% or more SAF, 60% or more SAF, 70% or more SAF, 80% or more SAF, 90% or more SAF, 95% or more SAF, 55% to 80% SAF, and 60% to 99% SAF, and all values and ranges within these values, as well as, lower percentages, e.g., 5%, 10%, 20%, 30%, 40%, from 5% to 15%, from 10% to 30% and less than 50%. Further, in an embodiment of the present invention there is provided a safe and effective aviation fuel that has 95% or more, 98% or more, and 99% or more and 100% SAF. Still further there is provided an SAF that has no technical blend limit. Preferably there is provided the forgoing SAFs that meet ASTM standards, and more preferably have obtained ASTM approval.

The need for renewable hydrocarbon-based materials, chemicals and fuels, including the need for renewable aviation hydrocarbon-based fuel, and including for a drop-in SAF, which does not required blending with convention jet fuel, has an additional long-standing and unsolved problem. Prior to the present inventions, plants (i.e., factories), systems and methods, such as SIP, SPK, ATJ-SKA, ATJ-CKA, ATJ-SPK, FT, FT-SPK, HEFA-SPK, HFS-SIP, FT-SPK/A, CH-SK, HC-HEFA-SPK, NETJ-SAK and the like, that were used to convert a synthetic or renewable hydrocarbon source into a renewable hydrocarbon product, e.g., renewable naphtha, SAF, etc., required that the plant, system and method be specifically tailored to a narrow range of synthetic or renewable hydrocarbon sources, and typically a single hydrocarbon source, e.g., a source having a range such as C1 to C4 alcohols. This problem of being tied to, or limited to, a single source is present both for the production of an in initial (or intermediate) product, such as syngas, ethers, LPG, alcohols, olefins, and naphthas, but also final products, such as SAF. This inability to use a wide range of synthetic or renewable hydrocarbon sources, and synthetic or renewable intermediate sources, has been an impediment to the adoption and economic production of renewable hydrocarbon-based materials, chemicals and fuels.

As used herein an unblended SAF refers to the SAF that has not been combined with aviation fuel. As used herein it will be understood that the products that are produced by the systems of the present inventions are unblended SAF, in that they have not been blended with aviation fuel during the process.

The present inventions, as described in this specification, figures and claims address and provide solutions to one or more and preferably all of these long-standing problems, as well as other problems.

Embodiments of the present inventions provide systems and methods that can use a wide range of synthetic or renewable feeds (e.g., renewable hydrocarbon sources, synthetic intermediate hydrocarbons), to provide renewable hydrocarbon end products and synthesized hydrocarbon end products, and combinations of these.

Embodiments of the present inventions provide systems equipment, systems and methods for using a wide range of feed sources including naphthas, alcohols, and light olefins to provide renewable fuels for combustion engines used in aviation, other transportation and power generation, including such fuels that are drop-in ready. In particular, preferred embodiments of such fuels, require minimal to no blending with convention hydrocarbons fuels.

Embodiments of the present inventions provide systems equipment, systems and methods for using a wide range of renewable naphtha feed sources to provide renewable fuels for aviation combustion engines and including such fuels that are drop-in ready. In particular, such fuels that do not require blending with convention hydrocarbons.

In an embodiment there is proved an SAF that is made essentially from synthetic hydrocarbon sources, renewable hydrocarbon sources or both, that is drop-in ready and that does not require blending with conventional hydrocarbons for use in aircraft; as well as, equipment, systems and methods to make such an SAF.

Embodiments of the present inventions, that address and solve these long-standing problems and needs, include combinations and variations of the forgoing and following embodiments.

Thus, there provided a system for producing a sustainable aviation fuel (SAF), the SAF having naphthenes and aromatics, the system having: a first reactor; and a second reactor; the first reactor having a first reactor first bed, a first reactor second bed and a first reactor third bed; wherein the first reactor beds are configured such that material flow is from the first bed to the second bed and then to the third bed; the first reactor first bed having an infeed line that provides a starting material having an alcohol, an ether, or a mixture of both, to the first reactor first bed; the first reactor second bed in fluid communication with a hydrocarbon source, wherein the hydrocarbon includes an alkene; the first reactor having a first reactor output line and configured to provide a first reactor product from the first reactor output line; the second reactor having three reactor beds; wherein the second reactor beds are configured such that material flow is from a second reactor first bed, to a second reactor second bed, and then to a second reactor third bed; the second reactor first bed having a second reactor infeed line that is in fluid communication with the first reactor output line; whereby the second reactor first bed is configured to receive at least some of the first reactor product; the second reactor having a second reactor output line and configured to provide a second reactor product from the second reactor output line; and, the system configured to provide one or more final products from the second reactor product, whereby at least one of the final products is an SAF having naphthenes and at least 3 weight % aromatics.

Moreover, there is provided these systems and methods having one or more of the following features: the first reactor further having a first reactor fourth bed; wherein the first reactor beds are configured such that material flow is from the third bed to the fourth bed and wherein the fourth bed includes the first reactor output line; a first reactor first bed outlet line, wherein the outlet line is in fluid communication with a first separator, whereby at least some of a first reactor first bed product is provided to the first separator; and wherein the first separator is configured to separate water from the first reactor first bed product and return a dewatered first reactor first bed product to one or more of the first reactor second bed, the first reactor third bed, and the first reactor fourth bed; the first reactor output line is in fluid communication with a stabilizing column, whereby the first reactor product is provided to the stabilizing column; the stabilizing column is configured to separate the first reactor product into at least two portions, a first portion having Cn hydrocarbons and a second portion having Cn′ hydrocarbons; the second reactor configured to receive the first portion of the first reactor product; whereby at least some of the first portion of the first reactor product is provided to the second reactor first bed; and, whereby the second reactor output line is in fluid communication with the stabilizer, whereby the second reactor product is provided to the stabilizing column.

Still further, there is provided these systems and methods having one or more of the following features: a hydrogenation reactor; a gas liquid separator; wherein the second portion having Cn′ hydrocarbons is provided to the hydrogenation reactor and the gas liquid separator; wherein an output from the hydrogenation reactor is provided to the gas liquid separator; whereby the gas liquid separator is configured to provide the SAF.

Additionally, there is provided these systems and methods having one or more of the following features: wherein the dewatered first reactor first bed product is provided to the second reactor; wherein the hydrocarbon source is the first reactor first bed; wherein the hydrocarbon source is the first reactor first bed product, the dewatered first reactor first bed product or both; wherein the starting material includes a C1 to C4 alcohol; wherein the starting material consists essential of ethanol; wherein the starting material includes a C1 to C4 alcohol; and the starting material is a renewable material; wherein there are no addition points for the addition of conventional hydrocarbons; wherein n is 3-5 in the first portion Cn hydrocarbons, whereby the hydrocarbons in the first portion includes hydrocarbons having a carbon number of C3-C5; and wherein n′ is 9+, whereby the Cn′ hydrocarbons in the second portion have a carbon number of C9+; wherein the alkene is ethylene; wherein the SAF includes at least 8 weight % aromatics; wherein the SAF includes 5% to about 25 weight % aromatics; wherein the SAF includes paraffins, and the amount of the paraffins is less than 50 weight %; wherein the SAF includes at least 8 weight % aromatics, paraffins and the amount of the paraffins is less than 50 weight % paraffins by weight; wherein the SAF includes paraffins and 30% to 90% naphthene; wherein the SAF has a carbon intensity (CI) of about 60 g/MJ or less; and, wherein the SAF has a CI of about 40 g/MJ or less.

In addition, there is provided a method of producing a sustainable aviation fuel (SAF), the SAF having naphthenes and aromatics, the method having: providing an infeed stock to a reactor, the infeed stock consisting essentially of a first component that is a synthesized hydrocarbon and a second component that is an alcohol, an ether or both; conducting a catalytic reaction on the infeed stock, to thereby provide an first intermediate hydrocarbon product; conducting a catalytic reaction on the first intermediate hydrocarbon product to thereby provide a second intermediate hydrocarbon product; hydrogenating at least some of the second intermediate hydrocarbon product; thereby providing an SAF having a paraffin and at least 3 weight % aromatics.

Yet further, there is provided these systems and methods having one or more of the following features: wherein the infeed stock has a carbon intensity (CI), and the SAF has a CI that is no more that 20% greater than the CI of the infeed stock; wherein the CI of the SAF CI is no more than 10% greater than the CI of the infeed stock; wherein the synthesized hydrocarbon is a synthesized naphtha; wherein the synthesized hydrocarbon is a renewable naphtha; wherein the alcohol is a renewable alcohol; wherein the ether is renewable; wherein second component is a C1-C4 alcohol and the second intermediate hydrocarbon has a carbon number of C9+; wherein the SAF includes at least 8% aromatics by weight; wherein the SAF includes 5 weight % to about 25 weight % aromatics; wherein the SAF includes paraffins, and the amount of the paraffins is less than 50 weight %; wherein the SAF includes at least 8 weight % aromatics, paraffins, and the amount of the paraffins is less than 50 weight %; wherein the SAF includes 30 weight % to 90 weight % naphthenes; wherein the SAF has a CI of about 60 g/MJ or less; and, wherein the SAF has a CI of about 40 g/MJ or less.

Furthermore, there is provided an unblended sustainable aviation fuel (SAF) having about 0-50 weight % n- and i-paraffins, from 30-90 weight % naphthenes and about 10-65 weight % aromatics, wherein the SAF is characterized by a blend limit, and wherein the blend limit is greater than 50 volume %.

Still further, there is provided these systems and methods having one or more of the following features: wherein the blend limit is 60 volume % and greater; wherein the blend limit is 100 volume %; wherein the SAF is drop in ready; wherein the SAF has a carbon intensity (CI) of about 60 g/MJ or less; and, wherein the SAF has a C1 of about 40 g/MJ or less.

Further embodiments of the present inventions that address and solve these and other long-standing problems and needs relating to renewable hydrocarbon production and products, synthesized hydrocarbon production and products, renewable fuels, synthesized hydrocarbon fuels, and combinations of these, as well as, their production, including equipment for their production, are set forth this specification, figures and claims.

### BRIEF DESCRIPTION OF THE DRAWINGS

FIG. 1 is a schematic of embodiments of materials and process flows in accordance with the present inventions.

FIG. 2 is a general schematic overview of embodiments of methods in accordance with the present inventions.

FIG. 3 is a schematic view of an embodiment of system and method in accordance with the present inventions.

FIG. 4 is a schematic view of an embodiment of a system and method in accordance with the present inventions.

FIG. 5 is a cross sectional schematic view of an embodiment of a fixed bed reactor assembly in accordance with the present inventions.

FIG. 6 is a schematic view of an embodiment of a system and method in accordance with the present inventions.

FIG. 7 is a schematic view of an embodiment of a system and method in accordance with the present inventions.

FIG. 8 is a schematic view of an embodiment of a system and method in accordance with the present inventions.

FIG. 9 is a schematic view of an embodiment of a system and method in accordance with the present inventions.

FIG. 10 is a schematic view of an embodiment of a system and method in accordance with the present inventions.

FIG. 11 is a table showing an embodiment of a mass balance for an embodiment of a process in accordance with the present inventions.

FIG. 12 is a table showing an embodiment of a mass balance for an embodiment of a process in accordance with the present inventions.

FIG. 13 is a table setting form some of the advantages and benefits of embodiments of processes and systems in accordance with the present inventions.

FIG. 14 is a chart showing as a sliding or relationship scale the various amounts of paraffins, naphthenes and aromatics for embodiments of end products that can be obtained in accordance with the present inventions.

FIG. 15 is a cross sectional schematic view of an embodiment of a fixed bed reactor assembly in accordance with the present inventions.

FIG. 16 is a schematic view of an embodiment of a system and method in accordance with the present inventions.

FIG. 17 is a schematic view of an embodiment of a system and method in accordance with the present inventions.

### DESCRIPTION OF THE PREFERRED EMBODIMENTS

The present inventions generally relate to systems, devices and methods that can utilize a wide variety of synthetic or renewable hydrocarbon starting materials and convert those materials using catalytic processes into a useful high value end product, such as a fuel for use in combustion engines. In a preferred embodiment this fuel is a drop-in-ready aviation fuel having an optimal composition of paraffinic, naphthenic and aromatic components for safe and effective operation of an aircraft.

In general, an embodiment of the present systems, devices and methods has the capability to use a large number of different and varying synthetic, including renewable, hydrocarbon starting materials, including raw hydrocarbon materials and intermediate hydrocarbon materials, as their feed stocks. Thus, the devices and systems can have as feed stocks one, two or more different conventional, synthetic, including renewable hydrocarbon sources and these feed stocks can remain the same over time or vary over time, e.g., day to day, week to week. The devices and systems are configured to control and regulate the conversion of the feed stocks, and particular varying feed stocks to provide an end product renewable hydrocarbon having predetermined properties and composition. Thus, in general the present systems, devices and methods can utilize a wide variety of conventional, synthetic, renewable hydrocarbon feed stock materials and combinations and variations of these, to produce various predetermined end products. In an embodiment the renewable hydrocarbon source would include such materials as renewable naphtha, synthetic and renewable alcohols, ethers, LPG or light olefins, renewable Hydrotreated Esters and Fatty Acids (“HEFA”), as well as others and combinations and variations of these; and the end product would include materials such as high value hydrocarbons such as gasoline, aromatic compounds that may be used as liquid organic hydrogen carriers for use in hydrogen fuel cells, aviation fuel, and in particular an SAF, and more preferably an SAF that is drop-in ready, and still more preferably does not have any blend limit, as well as others and combinations and variations of these.

In general, an embodiment of the present systems, devices and methods is a catalytic process (and system to carry out that process) of fuel-grade ethanol, methanol, or other alcohol conversion into SAF, BTX, or gasoline. The process utilizes a single-stage all gas-phase reaction to convert the initial hydrocarbon-containing feed into the valuable products of jet fuel range carbon number. The reaction mechanism contains an initial alcohol dehydration stage with subsequent dehydrocyclization, alkylation, and isomerization reactions, allowing the production of C9+ alkylated aromatics species by such a “hydrocarbon pool” type of reaction. Thus, in an embodiment the processing pathway includes: separating process reactions between multiple reaction spaces, operated at different conditions, which shifts the reaction towards selective production of the required molecule type with subsequent blending in required ratios.

It should be noted that while the focus of the present inventions is to utilize synthetic, renewable and both hydrocarbon sources to provide high value renewable hydrocarbon end products, such as SAF, embodiments of the present systems, methods and devices can use, and would include the use of, conventional hydrocarbon sources as some, most or essentially all of feed stock. Thus, in embodiments the feed stock can have 5% or more, 10% or more, 20% or more, from 1% to 40%, from 5% to 33%, no more than 50%, no more than 34%, no more than 25%, conventional hydrocarbons.

In general, the systems, devices and methods of the present invention preferably utilize a one- or two-stage catalytic conversion process and system, using for example a modified ZSM-5 zeolite catalyst, as well as, other types of zeolites. A preferred embodiment of these systems, devices and methods is a catalytic based system and process that uses one, two or more catalytic conversions and separation steps. This technology is a very flexible process upgrading any naphtha, alcohol, ether, LPG or olefin to a high value hydrocarbon product, such as gasoline, aromatic chemicals or jet fuel. The present inventions have discovered technologies, among other things, to utilize synthetized, including renewable, hydrocarbon feeds. Depending on the process mode, the resulting products may include renewable SAF, its components, and other valuable renewable commercial products. In this manner, a preferred product will be a renewable fuel, e.g., renewable jet fuel, sustainable aviation fuel (SAF), renewable gasoline, renewable chemicals, renewable liquefied petroleum gas (LPG) and renewable natural gas (RNG). In general, the present technology, among other things, increases the severity (e.g., space velocity, temperature, recycle) of the processes to produce renewable high value hydrocarbon end products, such as SAF.

In general, for the production of SAF, embodiments of the present systems and methods can be a two-stage embodiment, which can further have various recycle loops, and if desired, the hydrogenation of aromatics. Generally, in these embodiments, stage 1 processes a renewable naphtha with an alcohol or ether (or an alcohol or ether alone, or in a mix of alcohols and/or ethers) into a C3-C5 stream and a C6+ stream. The C3-C5 stream is combined with additional alcohol, ether or both and fed to stage 2, which generally operates at 460-550° C. An LPG slipstream is withdrawn from stage 2 and the remainder of the C3-C5 is recycled back to stage 2. The C6+ stream is further fractionated into a C6-C8 stream that is recycled to stage 1 and a C9+ stream, which is high aromatics SAF. A C5-C8 stream from the fractionator may be either withdrawn as the slipstream flow of renewable gasoline, or be recycled back to stage 1 (C6-C8 stream) and stage 2 (C3-C5 stream). The C9+ stream can then be hydrogenated to meet aromatics specifications, or blended without hydrogenation into a paraffinic SAF component, which component can be produced by third party methods.

This general SAF process, described above, may also be adapted for use in making liquid organic hydrogen carriers (LOHCs) or aromatics in general and in an adaptation for making renewable gasoline.

In embodiments of the present systems and processes utilize a catalytic process that converts fuel-grade ethanol, methanol, or other alcohols into SAF, BTX (benzene, toluene, and xylene), or gasoline. The process utilizes an all-gas-phase reaction to transform the initial hydrocarbon-containing feed into valuable jet fuel range carbon number products. The reaction mechanism consists of an initial alcohol dehydration stage, followed by subsequent oligomerization, dehydrocyclization, alkylation, and isomerization reactions, enabling the production of C9+ alkylated aromatic species through a so-called “hydrocarbon pool” reaction.

In embodiments of the present systems and processes, a feedstock source can be a methanol, that is made from an embodiment of a methanol production process that starts with gasification of any solid carbon bearing matter i.e. coal, biomass or reforming of natural gas, to produce syngas (CO, CO₂ and H₂), which is later used in the process to produce methanol via catalytic synthesis over Cu— based catalyst. Ethanol can be produced from petroleum via the chemical transformation of ethylene, but it can also be produced by fermentation of glucose, using yeast or other microorganisms; current fuel ethanol plants make ethanol via fermentation. Methanol that is produced via syngas is thereby viewed as synthetic, and its derivatives are also viewed as synthetic. Ethanol when produced from petroleum via ethylene is not synthetic.

It is to be understood that there are numerous chemical reactions that occur during the present processes. Some of the typical reactions that may take place, depending on various factor, such as the starting materials, are provided below. Upon contact with the zeolite catalyst, an alcohol yields a corresponding radical, e.g. methanol yields a methyl radical. The radical can react with itself to yield a longer-chain radical which can alkylate aromatic groups or be further converted to higher olefins and aromatics. The radical can also directly react with aromatics present in the feed to form high-octane alkyl-aromatics.

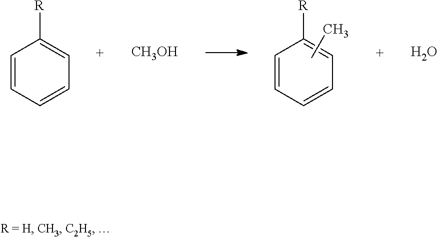

Apart from the alkylation of aromatic rings, the alcohol itself is converted into a mix of high-octane aromatics, naphthenes and paraffins. A simplified reaction pathway is described below using methanol as example.

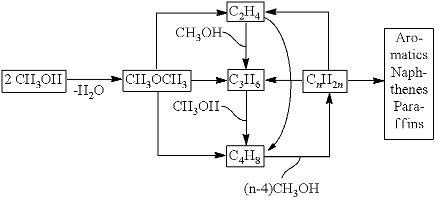

Every step in the pathway is an equilibrium reaction and hence the products of the conversion process will depend on process parameters.

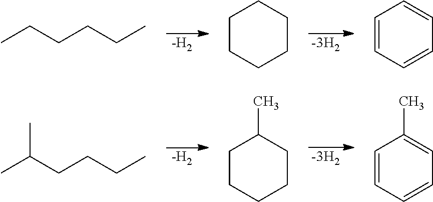

The pathway for ethanol reactions, which is an equilibrium reaction and hence the products of the conversion process will depend on process parameters, is shown below.

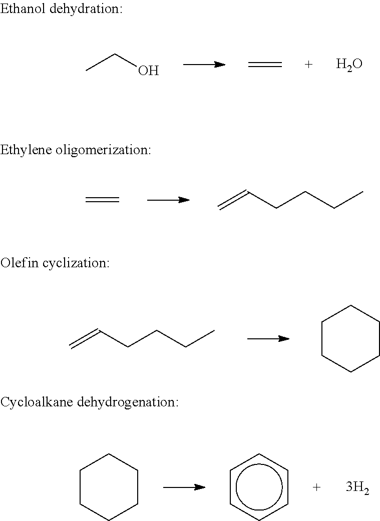

Olefins and dienes in the feedstock follow a similar conversion pathway. Newly formed aromatics can be further alkylated; paraffins and naphthenes can be further converted to isoparaffins and aromatics.

Paraffins are converted into aromatics and isoparaffins. The aromatization of paraffins occurs through intermediate formation of cycloalkanes.

Naphthenes in the current processes and equipment undergo dehydrogenation, yielding aromatics or unsaturated cyclic molecules with one or two pi-bonds, if the dehydrogenation is not done to extinction.

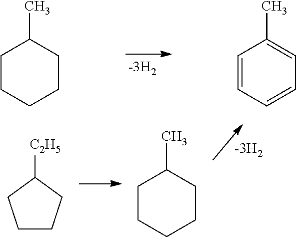

It should be understood that while the Specification discloses the use of specific types of reactions and processes, e.g., aromatization, dehydrocyclization, alkylation, and isomerization, the inventions are not so limited, and would generally include the use of any oligomerization type reactions and processes.

The catalysts, processes and equipment that are utilized in the present inventions generally relating to, and improve upon, FLEXIFORMING technology which is disclosed and taught in U.S. Pat. Nos. 10,131,592, 10,550,045, 10,550,331, 10,556,846, 11,427,770, and US Patent Publ. No. 2020/0291303, the entire disclosure of each of which is incorporated by reference. Thus, the present systems, devices, and methods described in this Specification can utilize, and improve upon, the teachings of FLEXIFORMING technology, and thus in this manner, and for such embodiments, would be new and non-obvious, improvements over, uses for, and adaptations of the FLEXIFORMING technology disclosed in the foregoing patents and applications. It is further understood that the present inventions are not limited to the use of FLEXIFORMING technology.

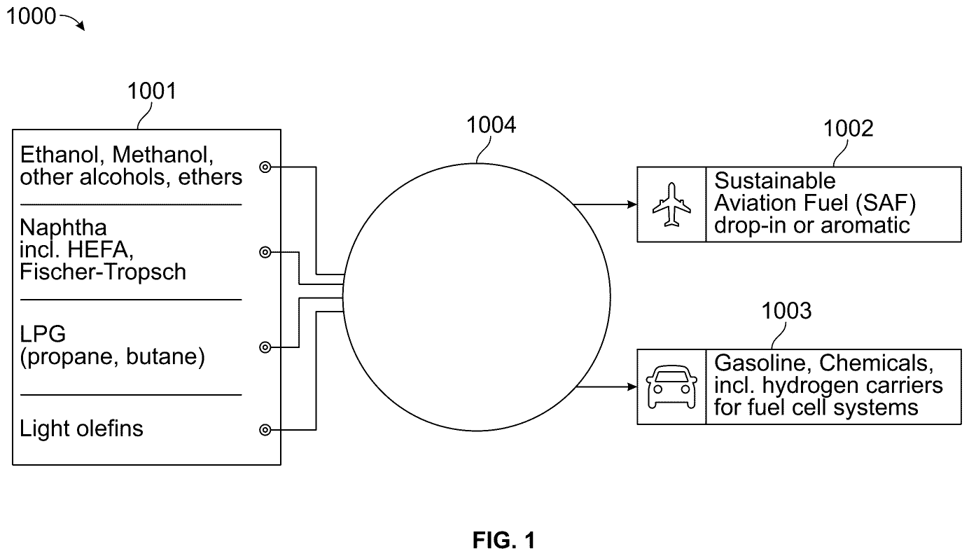

Turning to FIG. 1 there is provided a general schematic of an embodiment of a general materials and process flow 1000 to preferably make SAF 1002, and also make other renewable high value end products 1003 from different feed stocks 1001. It being understood that one or more of any renewable naphtha including from pyrolysis, liquifaction, green crude or derived from these such as fluid catalytic cracking (FCC) or hydrocracked vacuum gasoils from green crude, as well as, sustainable liquid petroleum gas (LPG) and fuel gas and hydrogen, among others, can be used as a feed stock 1001, for the present systems and processes 1003. The feed stock 1001 can be a single material, or type of material, or can be a blend or combination of materials. They can be be added by a separate lines, or mixed before or during feeding into the system.

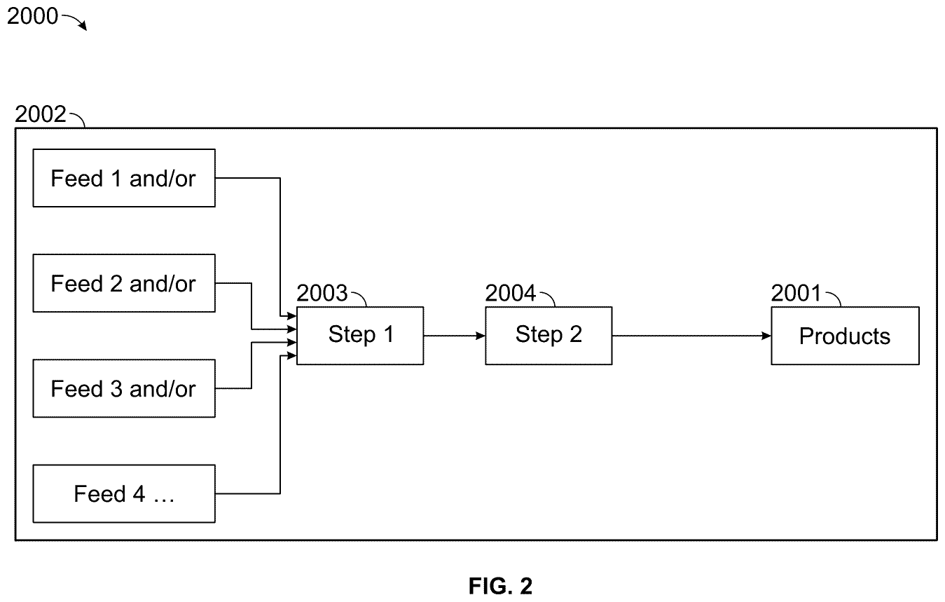

Turning to FIG. 2 there is provided a general schematic of an embodiment of a system and process 2000 to make a high value product 2001, e.g., SAF and renewable high value end products, from different feed stocks 2002. One, two, three, four or more different feed stocks can be used, in combination or serially, depending on among other things their availability. In general, the present equipment and processes can preferably have at least two steps or stages 2003, 2004.

The present systems and methods provide various pathways for producing SAF. These pathways provide SAF that falls within the existing, or and can fall within new, ASTM D 7566 Annexes at varying maximum % blend with conventional jet fuel. These pathways provide an SAF that will meet the eventually anticipated standard that allows for the SAF to be used interchangeably with aviation fuel, i.e., drop-in SAF.

For example, embodiments of pathways beginning with different renewable feedstock starting materials included:
Methanol
Ethanol
Other alcohol(s) or ethers
mix of methanol and ethanol
LPG
Light olefins
all of the naphtha pathways may have co-feed of methanol, ethanol, other alcohol(s) and/or ether(s) or mix thereof
naphtha from HEFA
naphtha from Fischer-Tropsch of syngas from biomass
naphtha from Fischer-Tropsch of syngas from green hydrogen+CO₂
naphtha from green crude from the processing of biomass including wet and dry pyrolysis, hydrothermal liquefaction, enhanced by solvent extraction. The green crude will typically need “severe cleanup” before processing in a typical refinery. The naphtha may be directly fractionated from the green crude in the initial atmospheric distillation column or may be naphtha produced from the conversion via FCC or hydrocracking of the vacuum gas oil from the green crude.

For example, embodiments of pathways due to different operation of the systems include:
SAF with typically >50% aromatics prior to hydrogenation.
aromatic SAF blended with SPK SAF to meet aromatics spec of 8-25%. This would typically apply when the present processes and equipment are integrated with HEFA or FT SAF production
SAF from stage 1 only i.e. the LPG (C3/C4) is not processed in stage 2
Gasoline
Aromatic molecules such as benzene and its alkylates (including without limitation toluene, xylenes, durene, etc.).

Combinations and variations of the above embodiments of pathways due to different operation of the systems and pathways beginning with different renewable feedstock starting materials can be utilized. Moreover, any of these pathways can be used with any synthetic hydrocarbon, and may further include conventional hydrocarbons.

The present systems, devices and methods have to ability to operate cost effectively at lower or smaller production capacities. Thus, the present systems can have a size or capacity to produce, for example, SAF at about 75 barrels per day (bpd), about 100 bpd or less, about 120 bpd or less, about 180 bpd or less and about 250 bpd or less. It being understood that larger and smaller size plants can be made.

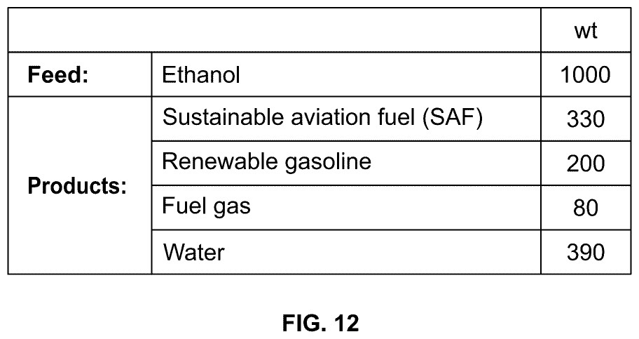

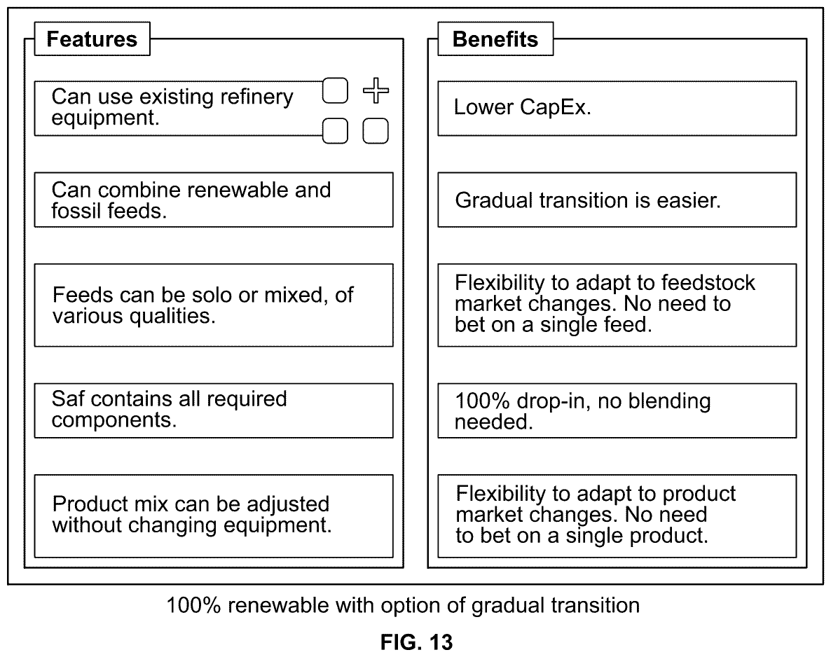

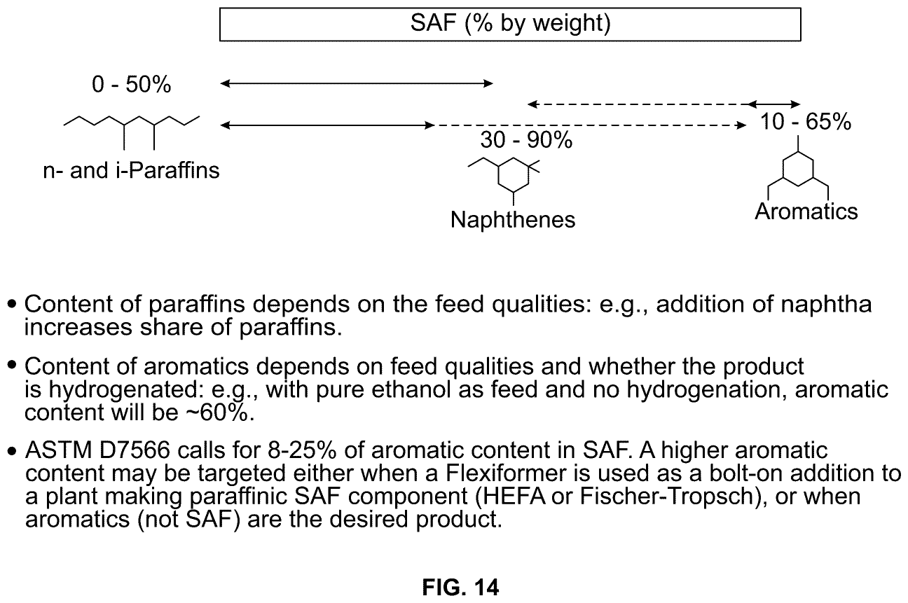

A preferred end product that is provided by the present systems, methods and devices is SAF. The SAF can be produced from any renewable hydrocarbon source listed above. This SAF has from about 0-50% n- and i-Paraffins, from about 30-90% Naphthenes and from about 10-65% Aromatics. A system can be adjusted through controlling the feed stock, the process conditions and both to provide an SAF with predetermined ratios of components. Turning to FIG. 12 there is shown a chart illustrating examples of the relationship of these components that can be obtained from the present systems and processes. Generally, the content of paraffins depends on the feed qualities: e.g., addition of naphtha increases share of paraffins. Generally, the content of aromatics depends on feed qualities and whether the product is hydrogenated: e.g., with pure ethanol as feed and no hydrogenation, aromatic content will be ~60%. It should be noted that ASTM D7566 calls for 8-25% of aromatic content in SAF. A higher aromatic content may be targeted and obtained, for example when present equipment is used as a bolt-on addition to a plant making paraffinic SAF component (HEFA or Fischer-Tropsch), or when aromatics (not SAF) are the desired product.

A significant advantage of the present systems and methods, when compared to prior systems and methods for providing SAF, such as HEFA, FT and PtL (power to liquids i.e. most commonly, renewable electricity via electrolysis to produce hydrogen combined with renewable source of CO₂ to then make syngas fed into a F-T system) is that the present systems and methods produce an SAF that contains aromatics and the content of aromatics can be regulated by hydrogenation. On the other hand, prior systems and methods to obtain SAF, such as HEFA, FT and PtL, produced SAFs that contained only paraffins, and had no aromatics. Aviation fuel, to be safe and effective, as well as, to meet regulatory requirements, requires at least 8% aromatics.

The present systems, devices and methods provide the ability to control and reduce the carbon intensity (CI) of its intermediate and end products. For example, present systems, devices and methods can provide a jet fuel having controlled and predetermined CI. In part, this ability to control the CI of end products comes from the ability of to use a wide range of starting materials, including a wide range of synthetic hydrocarbons, including renewable hydrocarbons, as well as, mixture of these with conventional hydrocarbons. Thus, by controlling the CI of the infeed starting materials, the CI of the end product, e.g., jet fuel can be controlled and controlled in a predetermined manner. The present system has an additional advantage of generating enough fuel gas from the feedstock so that very little of externally-supplied energy is required. Thus, generally the CI of end products from the present conversion process described herein depends primarily on the CI of the feedstock and thereby can be significantly lower than the CI of other processes to make similar end products like SAF.

CI is expressed in grams of carbon dioxide equivalents per megajoule of energy provided by that fuel. CI takes into account the GHG (greenhouse gas) generally associated with the emissions associated with the primary steps of producing, transporting and consuming a fuel. For the purpose of determining CI one of skill in the art would look to known calculation methods, and CI certificates of starting materials. Further, and specifically as used in this Specification, unless expressly stated otherwise, the term “Materials CI” for the end products is be based upon two factors, the CI of the starting materials, and the CI of the present processes to produce that end product.

The CI determination generally that takes into account all of the steps of producing, transporting, and consuming a fuel is known as a complete life cycle of that fuel, or a complete life cycle CI.

### EXAMPLES

The following examples are provided to illustrate various embodiments of the present systems, devices and processes, as well as various embodiments of renewable high value hydrocarbon end products. These examples are provided to illustrate various embodiments of the present inventions. These examples are for illustrative purposes, may be prophetic, and should not be viewed as limiting in any way, and do not otherwise limit the scope of the present inventions.

### Example 1

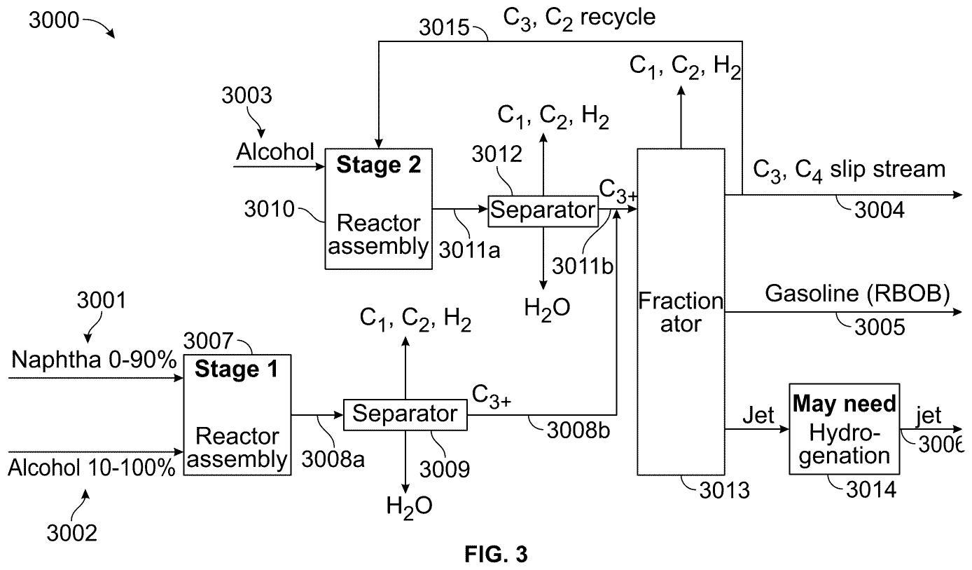

Turning to FIG. 3 there is shown a schematic of a general embodiment of a two-stage system and process 3000, for making SAF and other high value hydrocarbons, including synthesized hydrocarbons and renewable hydrocarbons.

In this example there are three infeed lines, 3001 (Naphtha 0-90% of total feed stock to stage 1), 3002 (Alcohol 10-100% of total feed stock to stage 1), 3003 (Alcohol to stage 2), which provide the starting materials (feed stocks) naphtha and alcohols. It is understood that other starting materials can be used, in addition to, or instead of, these starting materials. Such other starting materials can include materials, such as, LPG, ethers, naphthas, alcohols, olefins and light olefins. In this example, there are three end product streams which provide three end products. Stream 3004 is a C₃, C₄ slip stream. Stream 3005 is a gasoline (RBOB, i.e., Reformulated Blendstock for Oxygenated Blending). Steam 3006 is a jet fuel, which may also be hydrogenated. The gasoline product stream 3005 contains benzene, toluene and xylenes that may be separated and treated as separate products, collectively or individually.

The system and process 3000 has two stages, stage 1 (or at times Roman “I”) 3007 and stage 2 (or at times Roman “II”) 3010. Input streams 3001, 3002 are feed into stage 1 (3007), which has a reactor of the present types, e.g., Examples 4, 11. Stage 1 (3007) has an output stream 3008a that feeds into a first separator 3009, which separates out H₂O and C1, C2 hydrocarbons and H₂ from stream 3008a. The output stream 3008b from separator 3009 is made up of C3+ hydrocarbons.

Input stream 3003 is feed into stage 2 (3010), which has a reactor of the present type, e.g., Examples 4, 11. Stage 2 (3010) has an output stream 3011a which is feed into a second separator 3012, which separates out H₂O and C1, C2 hydrocarbons and H₂ from stream 3011a. The second separator 3012 has an output stream 3011b that is made up of C3+ hydrocarbons. Both streams of C3+ hydrocarbons 3008b, 3011b are feed into a fractionator 3013.

The fractionator 3013 further separators out remaining C1, C2 hydrocarbons and H₂. This stream can be used, for example, as refinery fuel gas for the system's needs (e.g., fuel for furnaces). The H₂ can be extracted at the refinery to for use in making more valuable materials or products, e.g., hydrogenation. The fractionator 3013 has three output streams. Stream 3004 is a slip stream having C3, C4 hydrocarbons. Stream 3005 is a gasoline. Steam 3006 is a jet fuel. There is also a recycle line 3015 that takes C3, C4 hydrocarbons from stream 3004 and returns them to stage 2. The jet fuel may also be passed through a hydrogenator 3014 and hydrogenation process.

In general, the system and method upgrades naphtha and alcohols and olefins to jet fuel, gasoline, liquefied petroleum gas (LPG), C3/C4, and combinations and variations of these. To the extent the feedstocks are renewable, the products will be also. Stage 1 is the first application of the present equipment and processing in the process. Stage 2 is the second application of the present equipment and processing, which is added to process C3/C4 to increase the yield of gasoline and jet fuel. Stage 2 represents the first step of increased severity of conditions. The process flow and equipment of Stage 2 is generally comparable to Stage 1, except the temperature is over 100° C. hotter in order to facilitate the reaction. And, as a second step of increased severity, the C3/C4 may be recycled back to stage 2.

In an embodiment, the naphtha 3001 is renewable naphtha derived from a renewable hydrocarbon source, such as vegetable and grain oils (e.g., corn, sun flower, soybean, canola), fatty acids and esters, algae, municipal wastes, waste water treatment sludge, biomass (including agriculture and forest waste as well as on purpose grown biomass), animal fats, alcohols, and FOG (cooking fats, oils and grease).

In an embodiment the alcohol (3002 or 3003 and preferably both) is methanol. C1-C4 alcohols may be used. C1-C4 ethers may also be used with or instead of alcohols.

In an embodiment the jet end product stream 3006 would be an SAF, and more preferably a drop-in SAF.

In an embodiment one or more and all of the infeed starting materials can preferably be a synthetic hydrocarbon.

### Example 2

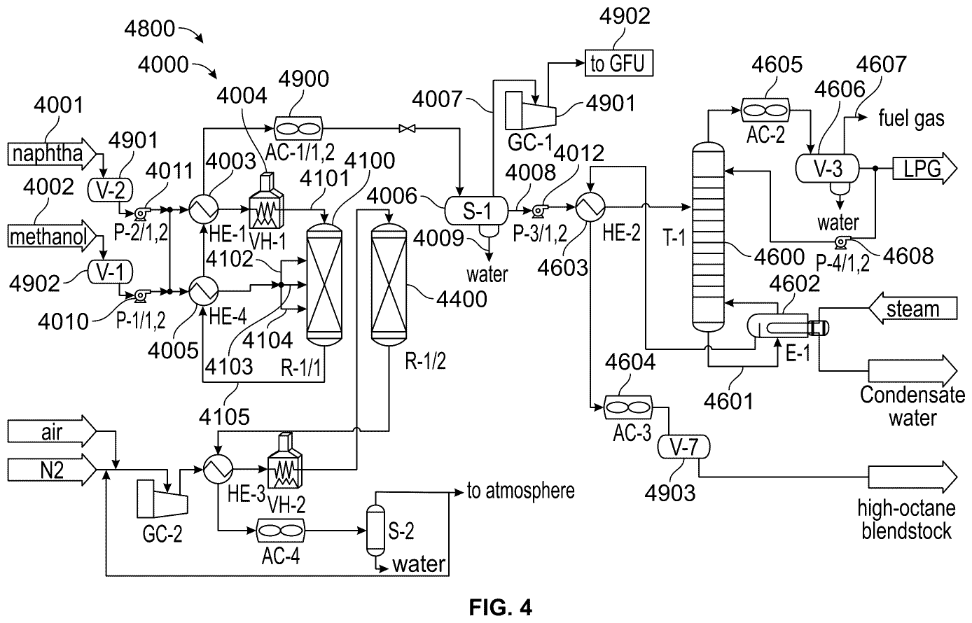

Turning to FIG. 4 there is shown a schematic of a general embodiment of a single stage system and process 4800, having a reactor assembly 4000, having two reactors 4100, 4400, for making LPG and a high octane blend stock, both of which can be synthesized and renewable, as well as, other high value hydrocarbons, including synthesized hydrocarbons and renewable hydrocarbons

In this example there are two infeed lines, 4001 (alcohol, e.g., naphtha), 4002 (methanol). C1-C4 alcohols may be used. C1-C4 ethers may also be used with or instead of alcohols.

The naphtha is preheated through heat exchanger 4003 and preheat furnace 4004 up to about 380° C. to the reactor inlet 4100 of reactor 4000. The alcohol, e.g., methanol, will be similarly preheated and divided into three separate streams, 4102, 4103, 4104 to be injected at the beginning of each of the reactor beds (shown in FIG. 4A). The alcohol can be divided into more or fewer streams. The alcohol, e.g., methanol, for the 1^{st} bed may be preheated all along with the naphtha or may be injected after preheating.

The reactor outlet stream 4105 is cooled by heat exchangers 4005 and 4003 and then separated, by separator 4006, into 3 phases: hydrogen rich gas 4007, hydrocarbon liquid 4008, water liquid 4009.

The hydrocarbon liquid 4008 is sent to fractionation which in the simplest form is stabilization by removing the LPG (C4−), and leaving a C5+×finished gasoline.

The system 4000 provides for the joint processing of feedstock at a feed pressure of 200 psia (1.5 Mpa) at the entrance of the mixer installations, from pump 4010 (P-1 MeOH) and from pump 4011 (P-2 naphtha). The reactor 4100 represents two similar reactors (R-1 4100 and reactor R2 4400), in alternately operating mode of reaction 4100—regeneration 4400. Thus, and preferably, there are two reactors in the system, and that processing is continuous, with one reactor always available for conducting the reaction, while the other is regenerating. (e.g., 800 hr on feed (i.e., reaction) and 2 days of regeneration)

There is also a vessel 4901 (V-2), a vessel 4902 (V-1) which can be small condensate chillers, and vessel 4903 (V-7) which can be a gasoline collector.

Heating and vaporization of naphtha and MeOH are performed sequentially in the recuperative heat exchanger 4003 (HE-1) and furnace 4004 (VH-1).

After heating to 680-806° F. (360-430° C.), the gaseous feed mixture is fed 4101 into reactor 4100 (R-1) or whichever reactor is on feed as they operate alternately. The catalytic process occurs in the reactor 4100 converting MeOH and naphtha into LPG and gasoline which exit the reactor 4100 as outlet stream 4105.

The reaction products in outlet stream 4105 are generally at a temperature of 680-806° F. (360-430° C.) and go to the tube side of the MeOH heat exchanger 4005 (HE-4) and then are cooled further in heat exchanger 4003 (HE-1), followed by air cooler 4900 (AC-1).

The reaction products cooled to about 95° F. (35 C) after leaving air cooler 4900 are then separated in a 3-phase separator 4006 (S-1). Gas from separator 4006 may be fed to the off gas compressor 4901 (GC-1) (if needed), then sent offsite via a gas filtration unit 4902 (GFU).

The liquid phase is stratified and decanted in separator 4006. The aqueous layer is sent to water treating or crude desalters, via stream 4009, and hydrocarbons go to pump 4012 (P-3), via stream 4008. From there, the hydrocarbon product (in stream 4008) is preheated in heat exchanger 4603 (HE-2) and directed to tower 4600 (T-1), which is a stabilizer which operates at a pressure 174 psia (1.2 MPa). The terms stabilizer and fractionator are used interchangeably in this specification. In the simplest mode tower 4600 (T-1) merely stabilizes the C5+ product, i.e., removes sufficient C4- to make suitable gasoline. In the more severe and complex operating mode tower 4600 (T-1) operates as a fractionator separating a C4-(or C5-) overhead and C6-C8 side stream and C9+ bottoms. This may be accomplished using two separate fractionating towers

The stabilized product is withdrawn from the bottom of tower 4600 (T-1) via line 4601, which infeeds to reboiler 4602 (E-1). The product after leaving 4602 (E-1) is cooled by heat exchanger 4603 (HE-2) and then further cooled by air cooler 4604 (AC-3) to 113° F. (45° C.) and is then routed off-site. In this example the product is a high-octane gasoline blend stock, and preferably a renewable high-octane gasoline blend stock, if renewable feedstocks are used.

The overheads, which are the products removed from the top of tower 4600 (T-1), are cooled in air cooler 4605 (AC-2) and fed into the reflux drum 4606 (V-3), which is a 3-phase separator. Uncondensed vapors from reflux drum 4606 (V-3) are routed to the fuel system as fuel gas via line 4607. A small amount of water is discharged to wastewater treating. The liquid hydrocarbon product is a C3/C4 fraction, which goes to pump 4608 (H-4) and is returned to tower 4600 (T-1) as reflux with the balance off-site as LPG.

To recover most of the C3+ from the fuel gas system, the fractionator overheads may be chilled through special refrigeration equipment or routed to a lean oil absorber. Neither of these options are shown in the figure. The lean oil may be C₅₊ or C6-C8 or C9+ depending on process design optimization. The rich oil with the absorbed C3+ is recycled to the fractionator where the C3/C4 is recovered in the LPG stream.

### Example 3

The two-stage system and process 3000 of Example 1 (FIG. 3) has as its stage 1 the reactor assembly 4000, or 1500 and has as its stage 2 a second reactor assembly 4000, or 1500 from Example 2 or 12. The system may also use the tower configuration 4600 or column 1730 of Example 2 or 12 as its fractionator.

### Example 4

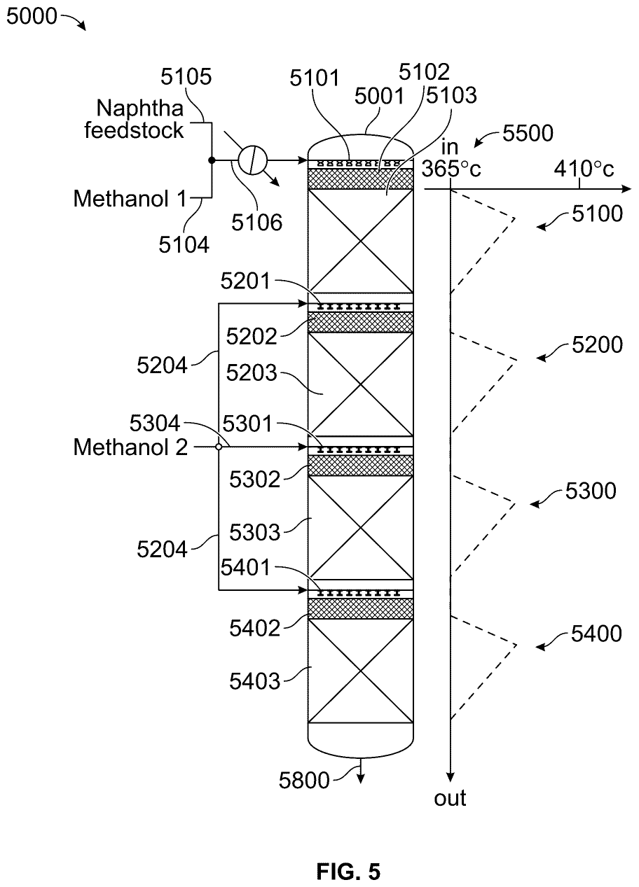

Turning now to FIG. 5, there is cross sectional schematic view of an embodiment of a reactor assembly 5000 having a reactor 5001 with infeed lines and infeed materials. The reactor 5001 and reactor assembly 5000 can be used in the systems and processes disclosed in this specification, including the systems and process of the other examples. It further being recognized that the infeed materials, and locations of the infeeds, as well as pressure and temperature, can be modified as per the teachings of this specification. Also, more and fewer sections or beds can be used.

The reaction of converting the naphtha together with an alcohol or ether (with methanol, or MeOH, used as an example) and/or olefins to produce LPG and gasoline is carried out in a fixed bed reactor 5100. C1-C4 alcohols may be used. C1-C4 ethers may also be used with or instead of alcohols.

Overall enthalpy change of the reaction mixture during the reaction is small. This is because the dehydration of MeOH producing water is highly exothermic, while the dehydrogenation of naphthenes is highly endothermic. In general, throughout the catalyst bed, it is desirable for the temperature to remain within ±27 F (15° C.).

The reactor 5001 is a multi-bed reactor having four beds 5100, 5200, 5300, 5400. Reactor bed 1 (5100) has injector 5101, a mixing zone 5102 and a reaction zone 5103. Reactor bed 2 (5200) has injector 5101, a mixing zone 5202 and a reaction zone 5203. Reactor bed 3 (5300) has injector 5301, a mixing zone 5302 and a reaction zone 5303. Reactor bed 4 (5400) has injector 5401, a mixing zone 5402 and reaction zone 5403. The catalysis and catalysis beds are in the reaction zones.

The beds contain at least one reactor shelf. Thus, the reactor is a 4-shelf reactor, with each bed assembly having a reactor shelf is used with separate alcohol (e.g., methanol or ethanol) infeed. (It being understood that more or less shelves can be used in a bed and more and less bed can be used in a reactor) Between the bed are mixing zones and distributors to inject the alcohol. This construction helps maintain the required temperature profile in the reactor regardless of the feedstock. The methanol treat rate as weight % of the naphtha may vary from 10 to >100%. The alcohol and olefins treat rate as weight % of the naphtha is the 3^{rd} for increasing severity with 10-20% typical for gasoline production and 100% for SAF. As used herein “treat rate” refers to the ratio of alcohol, expressed as a weight percentage, in relation to the hydrocarbon feed—in this case, naphtha. A treat rate of 100% for alcohol (or olefins) means that the mixture consists of equal masses of naphtha and alcohol, creating a 50/50 blend.

The multi-bed reactor 5001 has divided inputs of MeOH to each bed. Methanol is feed through infeed line 5204 to stage 5200. Methanol is feed through infeed line 5304 to stage 5300. Methanol is feed through in feed line 5404 to stage 5400. Methanol is feed by infeed line 5104 and is blended or mixed with the naphtha feedstock from infeed line 5105 and the mixture is feed into stage 5100 via input line 5106. The use of these multiple methanol addition points is used, among other things, to maintain a satisfactory temperature profile and reaction optimization. The temperature profile of the reactor is shown by temperature profile graph 5500.

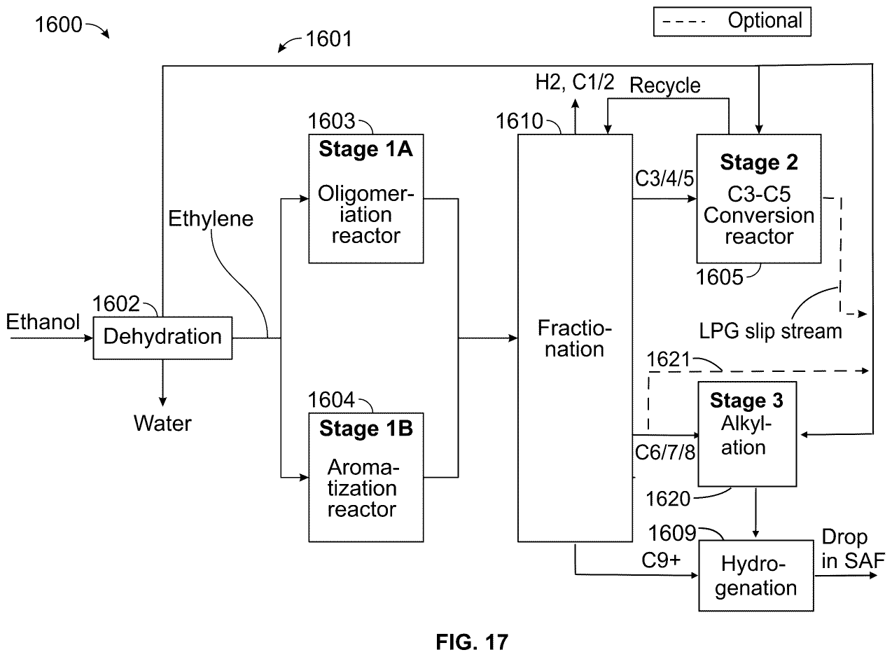

An example of process operating conditions for this reactor when used as the stage 1 reactor for the overall process (e.g., FIG. 3, 3000, FIG. 17, 1700):
Temperature, reactor inlet: 350-420° C. (662-788° F.); preferred 360° C. (680° F.).
Catalyst bed temperature: 330-400° C. (626-752° F.); preferred 337-350° C. (639-662° F.).
Reactor pressure: 0.3-0.9 MPa (44-130 psia); preferred 0.3 MPa (44 psi).
Space velocity, volume: 0.7-2 h-1; preferred 1.80 h-1. “h-1” indicates how many volumes of liquid pass through the same volume of catalyst per hour (e.g., 2 h-1 means the feed volume is two reactor/catalyst volumes per hour).
Pressure drop over the catalyst: <0.1 MPa (<15 psia).

The product from stage 1 output line 5800 is C1+ hydrocarbons, hydrogen and water. This stream would have the C4/C5 hydrocarbons separated out, for example as shown in FIG. 3, for infeed into the Stage 2 reactor.

An example of process operating conditions for this reactor when used as the stage 2 reactor for the overall process (e.g., FIG. 3, 3000) The process flow for the reactor in stage 2 is similar to that of stage 1 except: the feed is the C3/C4 from stage 1; temperature increased about 100° C.; and co-feed ratio may be different than for stage 1. For example, the co-feed may be up to 100% and a typical temperature is 450° C.

The process operating severity for the reactor in stage 2 will typically not be so high as to have 100% conversion of the C3/C4. When higher conversion is desired, the unconverted C3/C4 may be recycled back to stage 1. Stage 2 may have its own fractionator or may be combined in the stage 1 fractionator or in the liquid hydrocarbon from both stages 1 and 2 go to the same fractionator.

The product produced from stage 2 in this example can be an Octane number (RON) of the C5+ gasoline product and the product is regulated with co-feed fraction, i.e., fixture of methanol and naphtha in line 5106, as may also be regulated by overall all methanol and naphtha fraction by regulating amount of methanol added via inlets 5204, 5203, 5204, as well as by reactor bed temperatures, and combinations of these. This C5+ gasoline from this reactor and process can contain a heavy portion of C9+ that is in the distillation range for jet fuel.

### Example 5

The catalyst for use in any of the reactors, systems and processes disclosed in this specification, including for example the systems and process of the other examples, is generally in pellet form consisting of a high-silica zeolite of the pentasil group i.e. ZSM 5 and a binder containing silica and/or alumina. The zeolite is promoted using salts of zinc and rare earth elements. Further description of the catalyst is contained in UFT patents.

The catalyst is in the beds of the rectors and catalyst regeneration systems and capabilities will be a part of these systems.

Useful catalyst are disclosed and taught in U.S. Pat. No. 10,131,592, the entirety of which is incorporated herein by reference. Variants of these catalyst compositions may be used for stage 1 and 2 separately depending on the processing objectives. Thus, stage 1 and stage 2 catalyst can be the same and can be different. Further, the catalyst in each bed or shelf of a reactor can be the same or different.

### Example 6

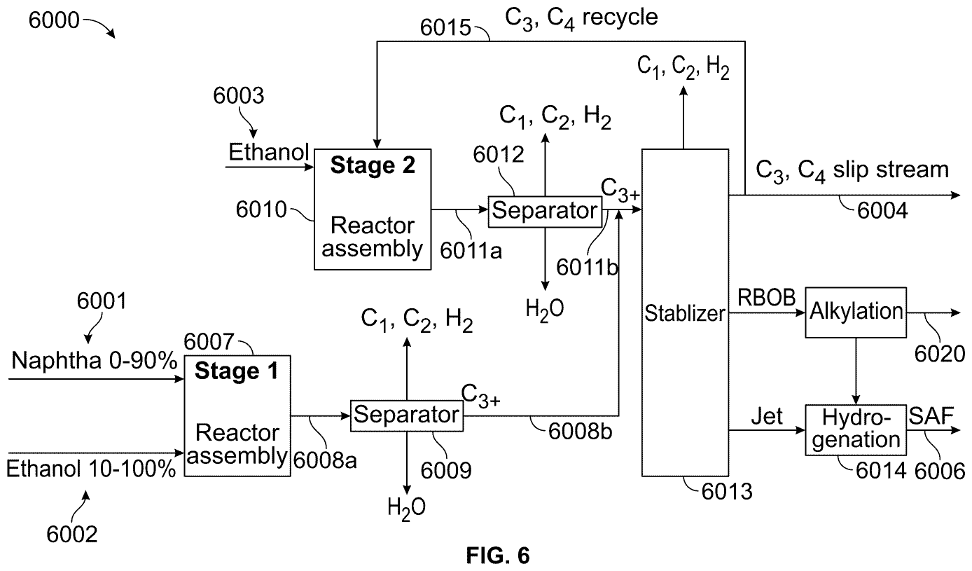

Turning to FIG. 6, there is shown a schematic of a general embodiment of a two-stage system and process 6000, for making SAF and other high value hydrocarbons, including synthesized hydrocarbons and renewable hydrocarbons. The general process conditions and description of the other examples, (e.g., Examples 1, 2, 4, 11, 12, 13) can be utilized in this Example. In this example there are three infeed lines, which provide the starting materials naphtha and ethanol. It is understood that other starting materials can be used, in addition to, or instead of, these starting materials. Such other starting materials can include materials, such as, LPG, ethers, naphthas, alcohols, olefins. The end products in this example are a C3, C4, gasoline (RBOB) and SAF.

In this example there are three infeed lines, 6001 (Naphtha 0-90% of total feed stock to stage 1), 6002 (ethanol 10-100% of total feed stock to stage 1), 6003 (ethanol), which provide the starting materials (feed stocks) naphtha and alcohols. It is understood that other starting materials can be used, in addition to, or instead of, these starting materials. Such other starting materials can include materials, such as, LPG, ethers, naphthas, alcohols, olefins and light olefins. C1-C4 ethers may also be used with or instead of alcohols. In this example, there are three end product streams which provide three end products. Stream 6004 is a C3, C4 slip stream. Stream 6005 is a gasoline (RBOB) that is sent through an allylation process 6020. Steam 6006 is a jet fuel, which is hydrogenated 6014 to provide an SAF. The gasoline product stream 6020 contains benzene, toluene and xylenes that may be separated and treated as separate products, collectively or individually.

The system and process 6000 has two stages, stage 1 (or at times Roman “I”) 6007 and stage 2 (or at times Roman “II”) 6010. Input streams 6001, 6002 are feed into stage 1 (6007), which has a reactor of the present type, e.g., Examples 4, 11. Stage 1 (6007) has an output stream 6008a that feeds into a first separator 6009, which separates out H₂O and C1, C2 hydrocarbons and H₂ from stream 6008a. The output stream 6008b from separator 6009 is made up of C3+ hydrocarbons.

Input stream 6003 is feed into stage 2 (6010), which has a reactor of the present types, e.g., Examples 4, 11. Stage 2 (6010) has an output stream 6011a which is feed into a second separator 6012, which separates out H₂O and C1, C2 hydrocarbons and H₂ from stream 6011a. The second separator 6012 has an output stream 6011b that is made up of C3+ hydrocarbons. Both streams of C3+ hydrocarbons 6008b, 6011b are feed into a fractionator 6013.

The fractionator 6013 further separators out remaining C1, C2 hydrocarbons and H₂, which are sent to a fuel gas collector. The fractionator 6013 has three output streams. Stream 6004 is a slip stream having C3, C4 hydrocarbons. Stream 6005 is a gasoline. Steam 6006 is a jet fuel. There is also a recycle line 6015 that takes C3, C4 hydrocarbons from stream 6004 and returns them to stage 2. The jet fuel may also be passed through a hydrogenator 6014 and hydrogenation process.

In general, the system and method upgrades naphtha and alcohols and olefins to jet fuel, gasoline, liquefied petroleum gas (LPG), C3/C4, and combinations and variations of these. To the extent the feedstocks are renewable, the products will be also. Stage 1 is the first application of the present equipment and processing in the process. Stage 2 is the second application of the present equipment and processing, which is added to process C3/C4 to increase the yield of gasoline and jet fuel. Stage 2 represents the first step of increased severity of conditions. The process flow and equipment of stage 2 is generally comparable to stage 1, except the temperature is over 100° C. hotter in order to facilitate the reaction. And, as a second step of increased severity, the C3/C4 may be recycled back to stage 2.

In a preferred embodiment, the naphtha 6001 is renewable naphtha derived from a renewable hydrocarbon source, such as vegetable and grain oils (e.g., corn, sun flower, soybean, canola), fatty acids and esters, algae, municipal wastes, waste water treatment sludge, biomass (including agriculture and forest waste as well as on purpose grown biomass), animal fats, alcohols, and FOG (cooking fats, oils and grease).

In an embodiment the alcohol (6002 or 6003 and preferably both) is ethanol. C1-C4 alcohols may be used. C1-C4 ethers may also be used with or instead of alcohols

In a preferred embodiment the jet end product stream 6006 would be an SAF, and more preferably a drop-in SAF.

In a preferred embodiment one or more and all of the infeed starting materials can preferably be a synthetic hydrocarbon.

In a preferred embodiment, the naphtha is renewable naphtha derived from a renewable hydrocarbon source, such as vegetable and grain oils (e.g., corn, sun flower, soybean, canola), fatty acids and esters, algae, municipal wastes, waste water treatment sludge, biomass (including agriculture and forest waste as well as on purpose grown biomass), animal fats, alcohols and FOG (cooking fats, oils and grease).

In an embodiment one or more of the ethanol infeed streams can contain methanol.

In a preferred embodiment the jet end product SAF, would be a drop-in SAF.

In a preferred embodiment one or more and all of the infeed starting materials can preferably be a synthetic hydrocarbon.

### Example 7

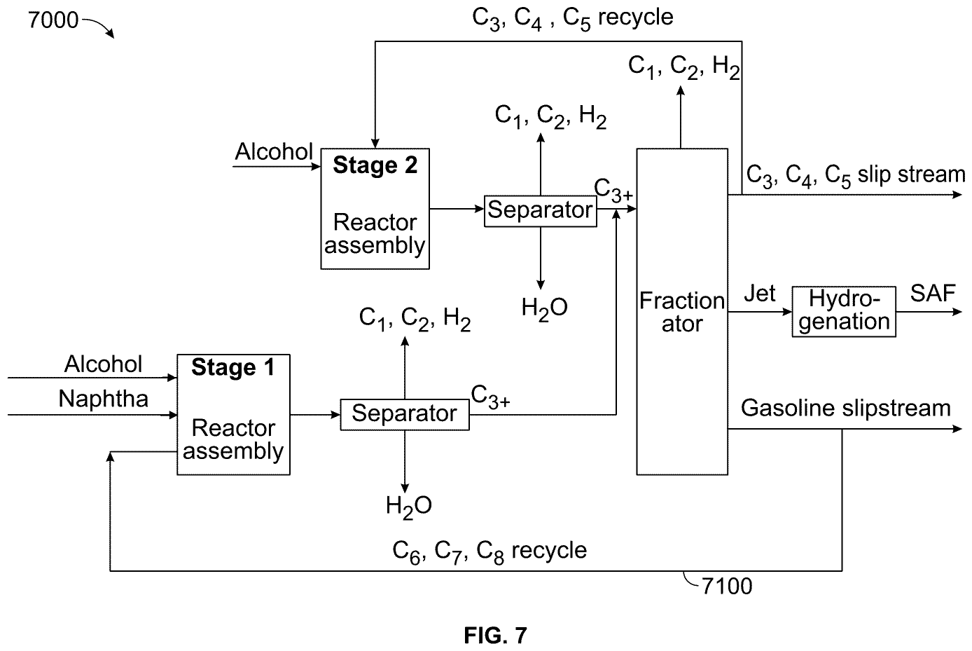

Turning to FIG. 7, there is shown a schematic of a general embodiment of a system and process for making SAF and other high value hydrocarbons, including renewable hydrocarbons 7000. The general process conditions and description the other examples, (e.g., Examples 1, 2, 4, 11, 12, 13) can be utilized in this Example. In this embodiment the system and process has been configured to maximize SAF production, and in particular, maximize SAF production from a variety of infeed starting materials.

In this embodiment the system and process have a recycle line and step 7100.

In this example there are three infeed lines, which provide the starting materials naphtha and alcohol. Two infeed lines are to stage 1, and a third infeed line to stage 2. It is understood that other starting materials can be used, in addition to, or instead of, these starting materials. Such other starting materials can include materials such as LPG, ethers, naphthas, alcohols, olefins. The end products in this example are a C₃, C₄, C₅, gasoline and SAF.

In an embodiment of this system and method there is a recycle of the C3-C5 and recycle of the C6-C8 and hydrogenation to produce SAF. Stage 1 and stage 2 receive “feed”. That feed can comprise of mixtures of naphtha, alcohols, olefins. And the amount of the gasoline and LPG slipstreams can be varied. And a special cut of benzene-toluene-xylenes or parts thereof can be separated from the gasoline. And the recycle composition are not fixed by the carbon number.

In a preferred embodiment, the naphtha is renewable naphtha derived from a renewable hydrocarbon source, such as vegetable and grain oils (e.g., corn, sun flower, soybean, canola), fatty acids and esters, algae, municipal wastes, waste water treatment sludge, biomass (including agriculture and forest waste as well as on purpose grown biomass), animal fats, and FOG (cooking fats, oils and grease).

In embodiment the alcohol is ethanol, methanol or both, or/and other alcohol(s) and/or ether(s).

In a preferred embodiment the SAF, would preferably be a drop in SAF.

In a preferred embodiment the infeed starting materials can preferably be for stage 1, for stage 2 and both a synthetic hydrocarbon.

FIG. 7 shows the 4th and 5th steps of increased severity for maximizing production of SAF. The fractionator will operate to include C₅ in the C₃/C₄ stream which is recycled to stage 1. And a second side stream of C₆-C₈ will be recycled to stage 1. This may be accomplished in one fractionating tower or 2 fractionating towers in which the first tower produces a C₃-C₅ overhead liquid and a C₆₊ bottoms stream which goes to the second tower producing a C₆-C₈ overhead stream and a C₉₊ bottoms stream. The C₆-C₈ may alternatively be processed through a separate alkylation reaction with a different catalyst and yet similar process to stage 1.

The process arrangement will typically include a C₃-C₅ slip stream and a C₆-C₈ slipstream to avoid buildup of undesirable trace components.

The embodiment of FIG. 7 contemplates the full range of feeds: naphtha, alcohol, olefins including both fossil-based and renewable. When the feed is naphtha, in particular renewable naphtha from Fischer-Tropsch or HEFA processing, the final step of SAF hydrogenation may not be needed. This is because the SAF from Fischer-Tropsch & HEFA is mostly paraffinic and the smaller quantity of SAF from the present processing of the associated renewable naphtha will be highly aromatic such that the combined SAF will contain <25% aromatics.

### Example 8

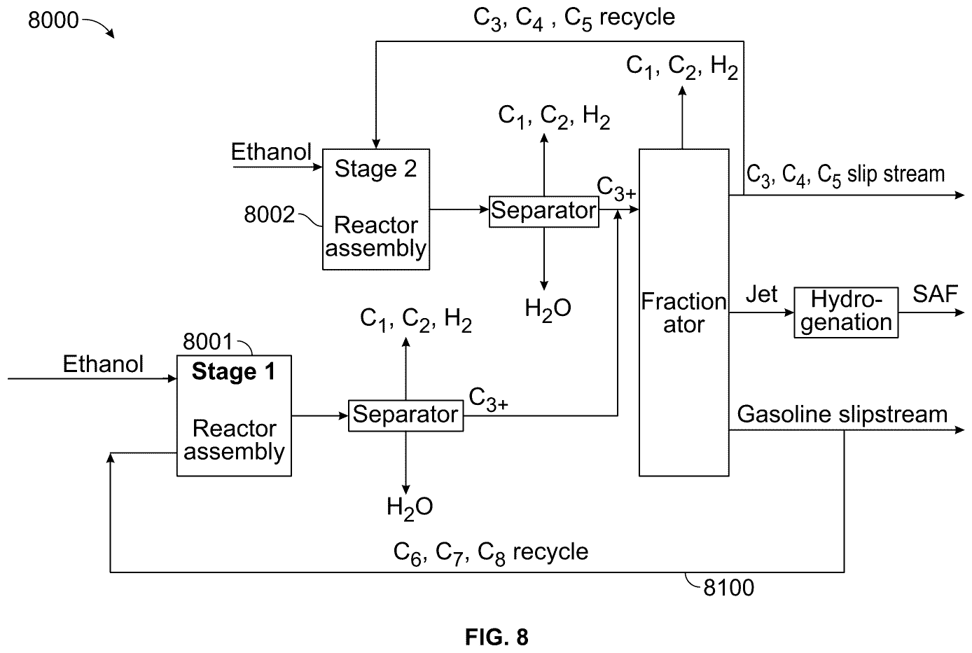

Turning to FIG. 8, there is shown a schematic of a general embodiment of a system and process 8000 for making SAF and other high value hydrocarbons, including renewable hydrocarbons. The general process conditions and description of the other examples, (e.g., Examples 1, 2, 4, 11, 12, 13) can be utilized in this Example. In this embodiment the system and process has been configured to maximize SAF production, and in particular, maximize SAF production from an infeed starting material of ethanol 8001, 8002.

In this embodiment the system and process have a recycle line and step 8100.

In this example there are two infeed lines, which provide the starting material ethanol. One infeed line is to stage 1, and a second infeed line is to stage 2.

It is understood that other starting materials can be used, in addition to, or instead of, these starting materials. Such other starting materials can include materials, such as, LPG, ethers, naphthas, alcohols, olefins and light olefins. The end products in this example are a C3, C4, C5, gasoline and SAF.

In a preferred embodiment the jet (SAF) end product would be a drop in SAF.

In a preferred embodiment the infeed starting materials can preferably be for stage 1, for stage 2 and both a synthetic hydrocarbon.

In this embodiment for the processing of ethanol to SAF pathway, ethanol is combined with the C₆-C₈ recycle in stage 1 which in a typical operation will have an ethanol treat rate of 100% i.e. ethanol feed rate to stage 1 equals C₆-C₈ feed rate to stage 1. Similarly, the ethanol treat rate to stage 2 will typically be about 100% i.e. ethanol feed rate to stage 2 equals C₃-C₅ feed rate to stage 2. These treat rates will vary depending on the detailed yields from each stage and the amount of C₃-C₅ and C6-C8 slipstreams.

In the high severity SAF operating mode, the C₆-C₈ fraction contains a high proportion of toluene and xylene which may be sold as a high octane renewable gasoline blendstock or as a renewable chemical feedstock or as the beginning component for liquid organic hydrogen carrier (LOHC).

### Example 9

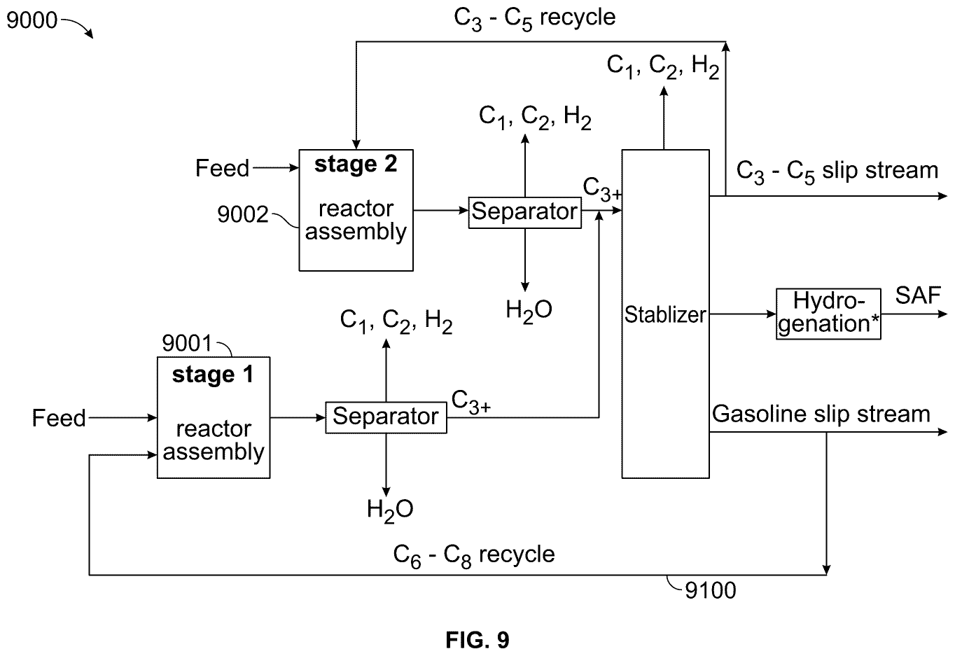

Turning to FIG. 9, there is shown a schematic of a general embodiment of a system and process 9000, for making SAF and other high value hydrocarbons, including renewable hydrocarbons. The general process conditions and description of the other examples, (e.g., Examples 1, 2, 4, 11, 12, 13) can be utilized in this Example. In this example there are two infeed lines 9001, 9002, which provide the starting materials. In this embodiment the system and process have a recycle line and step 9100. The starting materials can include materials, such as, LPG, ethers, naphthas, alcohols, ethanol, methanol, olefins. The end products in this example are a C₃, C₄ C₅, gasoline and SAF.

In this example, when ethanol is used as the infeed material the system provides for the dehydration of ethanol into ethylene, dehydrocyclization of light olefins (aromatization), alkylation of aromatics, oligomerization and isomerization.

In a preferred embodiment the SAF would be a drop in SAF.

In a preferred embodiment one or more and all of the infeed starting materials can preferably be a synthetic hydrocarbon.

### Example 10

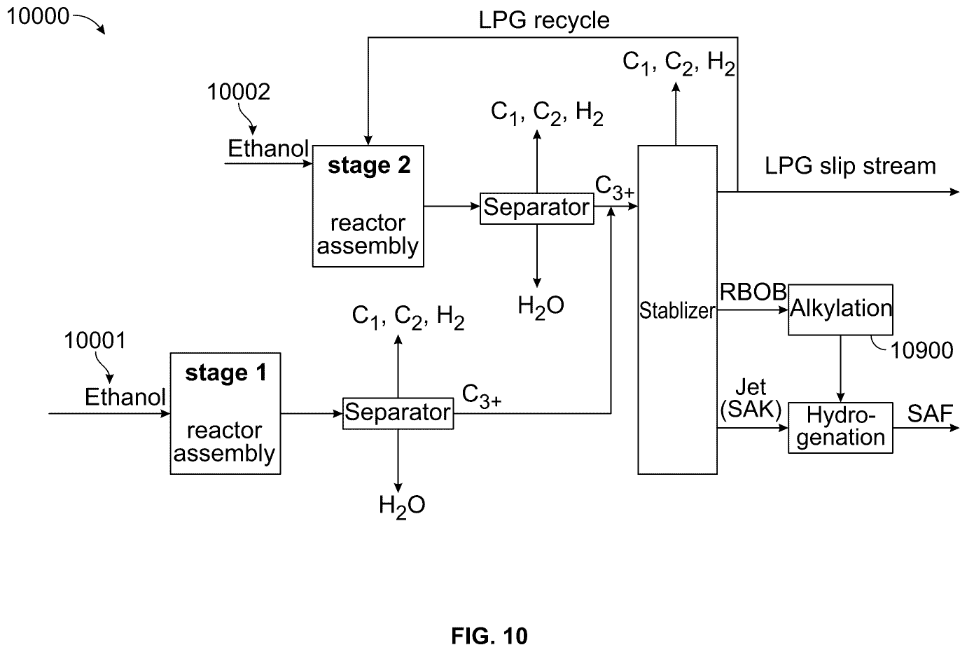

Turning to FIG. 10, there is shown a schematic of a general embodiment of a system and process 10000, for making SAK (synthetic aviation kerosine) and other high value hydrocarbons, including renewable hydrocarbons. The general process conditions and description of the other examples, (e.g., Examples 1, 2, 4, 11, 12, 13) can be utilized in this Example.

The system 10000 has two ethanol infeeds 10001, 10002 and an alkylation step 10900.

In this example there are two infeed lines, which provide the starting material ethanol. One infeed line is to stage 1, and a second infeed line is to stage 2. It is understood that other starting materials can be used, in addition to, or instead of, these starting materials. Such other starting materials can include materials, such as, LPG, ethers, naphthas, alcohols, olefins and light olefins. The end products in this example are LPG, gasoline (RBOB), RNG and SAF.

In a preferred embodiment the SAK would be a drop in SAK.

In a preferred embodiment one or more and all of the infeed starting materials can preferably be a synthetic hydrocarbon.

### Example 11

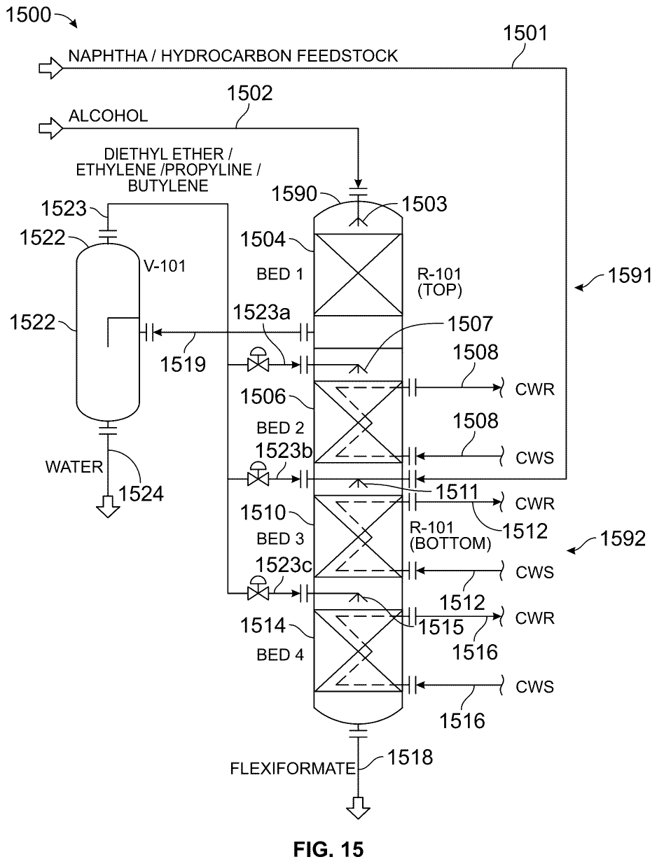

Turning now to FIG. 15, there is cross sectional schematic view of an embodiment of a reactor assembly 1500 having a reactor 1590 with infeed lines, infeed or starting materials and a separator. The reactor 1501 and the reactor assembly 1500 can be used in the systems and processes disclosed in this specification, including the systems and process of the other examples. It further being recognized that the infeed materials, and locations of the infeeds, as well as pressure and temperature, can be modified as per the teachings of this specification. Also, more and fewer sections or beds can be used.

The components of reactor assembly 1500 and the processes of the method shown in FIG. 15 are summarized below.
1500 reactor assembly
1501 infeed line (hydrocarbon)
1502 infeed line (alcohol)
1503 alcohol injector
1504 bed 1 (with catalyst)
1506 bed 2 (with catalyst)
1507 injector (dewatered bed 1 product)
1508 cooling water
1510 bed 3 (with catalyst)
1511 injectors (dewatered bed 1 product and/or hydrocarbon)
1512 cooling water
1514 bed 4 (with catalyst)
1515 injector (dewatered bed 1 product)
1516 cooling water
1518 output line (reactor product)
1519 output line (bed 1 product)
1522 separator
1523 output line (separator dewatered bed 1 product)
1523a Infeed line to bed 2 (dewatered bed 1 product)
1523b infeed line to bed 3 (dewatered bed 1 product)
1523c infeed line to bed 4 (dewatered bed 1 product)
1524 output line (water)
1590 reactor
1591 reactor top section
1592 reactor bottom section

The reactor assembly 1500 is preferably used as stage 1 in the system. The reactor 1590 has two main parts: the top section 1591 and the bottom section 1592. The top section (which contains bed 1 1504) is dedicated solely to alcohol dehydration, while the bottom section (which contains bed 2 1506, bed 3 1510, and bed 4 1514) is where the main reactions of the present occur, including oligomerization, aromatization, alkylation, and further isomerization. Although the present process allows to process different types of alcohols (methanol, ethanol, isopropanol, etc.), further technical description will be based on ethanol processing as an example, and to illustrate process intermediates and reactions features.

Bed 1 1504—alcohol (ethanol) is introduced into the top section, evenly distributed throughout the reaction volume using a distributor or injector 1503, e.g., a spray nozzle. This section operates as a fixed-bed reactor with a commercially available alcohol dehydration catalyst, based on Al₂O₃. The reaction occurs in the gas phase at temperatures ranging from 200 to 250° C. and pressures between 30 to 50 Bar (g), with a liquid hourly space velocity (LHSV) of 1 h⁻¹. Ethanol dehydration is an endothermic reaction that requires elevated temperatures, which are achieved through a feed preheating (not shown on the figure) and reactor heating methods, such as a steam-heated jacket, electrical heating, or internal heating pipes. Ethanol is entirely dehydrated into water and ethylene. The resulting mixture of hydrocarbons and water is then condensed and separated using a side-placed gas/liquid separator 1522. Bed 1 and side-placed separator must be operated at higher pressures then consequents Beds 2, 3 and 4 in order to distribute the Ethylene by means of pressure difference. Ethylene is also heated up to 350° C. before being distributed to Bed 2 1506.

There is no direct connection of Bed 1 1504 and Bed 2 1506 of the reactor 1590. Bed 1 can be considered as the dead shelf. Mixture of dehydration products (ethylene and water) is fully transferred to separator 1522 (V-101), via line 1519. And then, part of the Ethylene goes from separator 1522 (V-101) to bed 2 1506, part to bed 3 1510 and the residual Ethylene goes to bed 4 1514. Water is constantly drained (via output line 1524) from side-placed gas/liquid separator 1522 and eliminated from further processing.

Bed 2 1506-A portion of the ethylene and unseparated remainders of water vapors, (the ethylene leaving the separator 1523 via line 1523 is 95-99% dewatered, i.e., there is 1 to 5 wt % water remaining in the ethylene) is feed through input line 1523a into Bed 2 1506, where in passes through a specially treated zeolite catalyst in bed 2, where the ethylene undergoes oligomerization to form olefins, naphthenes, and aromatics. This process is highly exothermic, raising the temperature from 350° C. to 450° C. The products from bed 2 need to be cooled back down to 350° C. before being sent to bed 3 1510. Cooling is done by means of heat exchange between reaction volume and internally placed coil, supplied with a cooling water 1508.

Bed 3 1510—All oligomerized products (olefins, naphthenes, and aromatics) and any unconverted ethylene, along with remaining water vapor from bed 2, are combined with 25 wt. % of the dewatered ethylene from input line 1523b, as well as all naphtha (via infeed line 1501) that has been preheated to 350° C. Total volume ratio between added naphtha and hydrocarbon products coming from bed 2 is 1:1. In bed 3, ethylene reacts with the naphtha feed and naphtha produced in bed 2 to generate higher molecular weight naphtha, specifically targeting C9+. This reaction is also highly exothermic, increasing the temperature from 350° C. to 450° C. The products from bed 3 are then cooled back to 350° C. by means of cooling coils and cooling water 1512 then and distributed to bed 4 1514.

Bed 4 1514—All of the upgraded naphtha and oligomerized products from bed 3 1520, along with water vapor, are combined with 20-25% of the dewatered ethylene via infeed line 1523c. In bed 4, further alkylation of the naphtha occurs, again targeting higher molecular weight products aimed at C9+. This reaction is also highly exothermic, and the products from bed 3 are cooled back to 350° C. by means of cooling coils and cooling water 1516. Additional external heat exchange (not shown on the diagram) between Bed 4 products and ethanol or/and naphtha feedstocks may be applied to preheat the feedstock so as to reduce the furnace duty. The reaction product from bed 4 then exits the reactor via output line 1518, for further processing by the system.

### Example 12

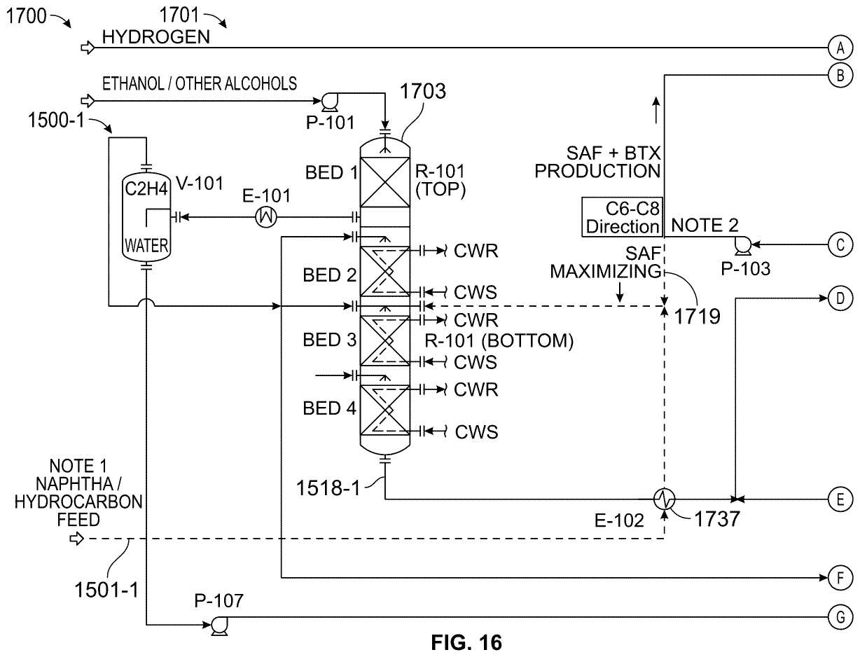

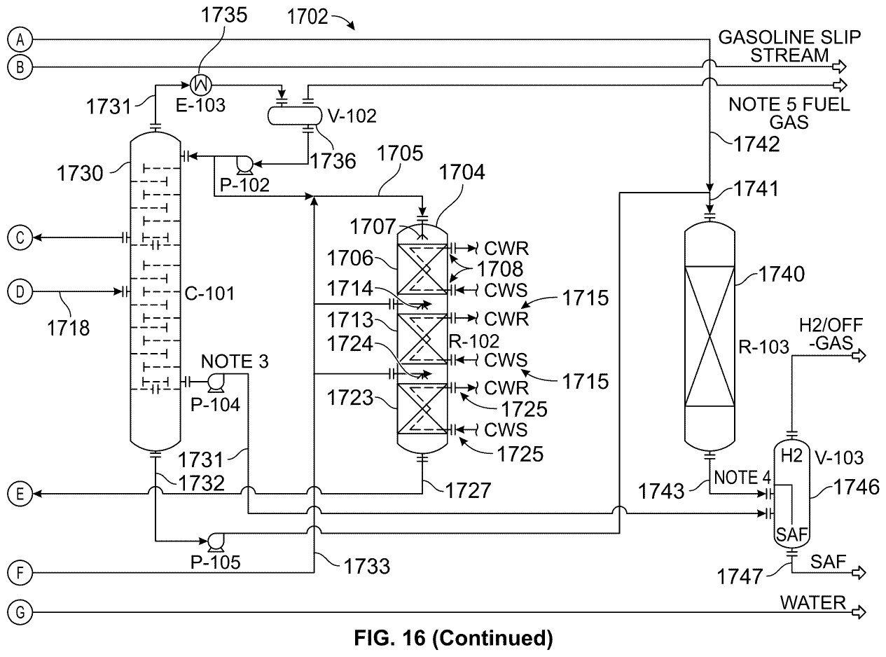

Turning now to FIG. 16, there is shown a schematic of a general embodiment of a two-stage system and process 1700, for making SAF and other high value hydrocarbons, including synthesized hydrocarbons and renewable hydrocarbons. In system 1700 the reactor assembly 1500 of Example 11 (FIG. 15) is used as the stage 1 reactor 1703; with only slight changes as evidenced by the drawings and as discussed below. Thus, reactor assembly 1500-1 is essentially the same as reactor assembly 1500; and the first reactor (or reactor 1) 1703 is essentially the same as reactor 1590. (All of the components and structures in 1500-1 and 1703 are the same as discuss regarding those components and structures in FIG. 15 (items 1500 and 1590); except hydrocarbon infeed line 1501-1 is now optional, feed line 1733 is added, and an optional infeed line 1719 is added to reactor assembly 1500. Thus, other lead lines and item numbers for reactor assembly 1500-1 have been omitted in FIG. 16.) In this figure (FIG. 17) dashed lines indicate optional flows/configurations of the system 1700.

The components of two-stage system 1700 and the processes of the method shown in FIG. 16 are summarized below.
1700 system and process (2 stage)
1701 stage 1
1702 stage 2
1703 reactor 1
1704 reactor 2
1705 reactor 2 infeed line (first portion of reactor 1 product & dewatered reactor 1, bed 1 product)
1706 reactor 2, bed 1
1707 injector (first portion of reactor 1 product)
1708 cooling water
1713 reactor 2, bed 2
1714 injector (dewatered reactor 1, bed 1 product)
1718 infeed to stabilizing column (reactor 1 product & reactor 2 product)
1719 infeed to reactor 1 from stabilizing column
1723 reactor 2, bed 3
1724 injector (dewatered reactor 1, bed 1 product)
1725 cooling water
1727 reactor 2 output line (reactor 2 product)
1730 stabilizing column
1731 output line (first portion of reactor 1 product)
1732 output line (second portion of reactor 1 product)
1733 feed line (dewatered reactor 1, bed 1 product)
1735 condenser
1736 reflux vessel
1737 heat exchanger
1740 hydrogen reactor
1741 infeed line hydrogen reactor (second portion of reactor 1 product & Hydrogen)
1742 infeed line hydrogen
1743 output/infeed line (hydrogen reactor to gas liquid separator)
1746 gas liquid separator
1747 output line (final product/SAF)

The embodiment in the example utilizes a catalytic process that converts fuel-grade ethanol, methanol, or other alcohols into SAF, BTX, or gasoline. The process utilizes an all-gas-phase reaction to transform the initial hydrocarbon-containing feed into valuable jet fuel range carbon number products. The reaction mechanism consists of an initial alcohol dehydration stage, followed by subsequent dehydrocyclization, alkylation, and isomerization reactions, enabling the production of C9+ alkylated aromatic species through a so-called “hydrocarbon pool” reaction.

Ethanol (or other types of alcohol) is fed into the head of Stage 1 1701 reactor 1 1703 (R-101).

The Stage 1 1701 reactor 1 1703 consists of two main parts: the top section R-101 (TOP) and the bottom section R-101 (BOTTOM). The top section is dedicated solely to alcohol dehydration, while the bottom section is where the primary Flexiforming reactions take place, including oligomerization, aromatization, alkylation, and further isomerization. Although the Flexiforming process allows for the processing of different types of alcohols (methanol, ethanol, isopropanol, etc.), the following technical description will focus on ethanol processing to accurately describe the process intermediates and reaction features.

Reactor 1 1703, Bed 1—Alcohol (ethanol) is introduced into the top section and evenly distributed throughout the reaction volume using a distribution device. This section operates as a fixed-bed reactor with a dehydration catalyst based on Al 2 O 3. In one implementation, bed 1 is constructed as a separate reactor, installed upstream of R-101. The reaction occurs in the gas phase at temperatures ranging from 200 to 250° C. and pressures between 30 and 50 Bar (g), with a liquid hourly space velocity (LHSV) of 1 h⁻¹. Ethanol dehydration is an endothermic reaction that requires elevated temperatures, achieved through feed preheating (not shown in the diagram) and reactor heating methods, such as a steam-heated jacket, electrical heating, or internal heating pipes. In one implementation, the heating medium sent to the heat exchange device of bed 1 is a product of Beds 2-4 of R-101 or R-102, which is heated by the exothermic effect of the corresponding reactions. Ethanol is fully dehydrated into water and ethylene. The resulting mixture of hydrocarbons and water is then condensed in heat exchanger E-101 and separated using a side-placed gas/liquid separator, V-101. In one implementation, the mixture of ethylene and water is separated within R-101 in an expressly provided volume under bed 1. Bed 1 and the side-placed separator, V-101, must operate at higher pressures than the subsequent Beds 2, 3, and 4 or the R-101 (BOTTOM) reactor to allow for the distribution of ethylene via pressure difference. The cold flow of ethylene produced by Bed 1 is a quench for the subsequent Beds of reactors R-101 and R-102. Water is continuously drained from the side-placed gas/liquid separator, V-101, and eliminated from further processing. Using a separate Bed for alcohol dehydration offers additional benefits: the product flow, consisting of ethylene and water, can be separately cooled for better water separation. If additional feed and/or recycle formed by C-101 is mixed with alcohol, cooling the product for water separation will necessitate higher energy consumption due to the increased flow capacity. Mixing all flows will also require heating them after water separation to reach the required operating temperature of the subsequent Beds.

Reactor 1 1703, Bed 2-A portion of the ethylene and unseparated remainders of water vapors passes through a specially treated zeolite catalyst, where the ethylene undergoes oligomerization to form olefins, naphthenes, and aromatics. This process is highly exothermic, raising the temperature from 350° C. to 450° C. The products from bed 2 need to be cooled back down to 350° C. before being sent to bed 3. Cooling uses heat exchange between reaction volume and internally placed coil, supplied with the cooling water according to one of the implementations. Another implementation comprises using cold feed flow for heat removal from beds 2-4 of R-101.

Reactor 1 1703, Bed 3-All oligomerized products (olefins, naphthenes, and aromatics) and any unconverted ethylene, along with remaining water vapor from Bed 2, are combined with a portion of the ethylene from Bed 1 and hydrocarbon feed that has been preheated to 350° C. Hydrocarbon feed injection is optional and depends on the goal of processing. Naphtha or other hydrocarbon feeds may be introduced as an individual feed flow (as part of the upgrading process for already existing naphthas, such as HEFA). Additionally, the C6-C8 fraction from stabilizing column C-101 may be recycled and injected into Bed 3 to maximize SAF production. The total volume ratio between added naphtha and hydrocarbon products coming from Bed 2 may vary; one implementation features a ratio of 1:1. In this bed, ethylene reacts with the naphtha feed and the naphtha produced in Bed 2 to generate higher molecular weight naphtha, specifically targeting C9+. This reaction is also highly exothermic, raising the temperature from 350° C. to 450° C. The products from Bed 3 are then cooled back to 350° C. using cooling coils and distributed to Bed 4.

Reactor 1 1703, Bed 4-All of the upgraded naphtha and oligomerized products from bed 3, along with water vapor, are combined with a portion of the ethylene from bed 1. In this bed, further alkylation of the naphtha occurs, again targeting higher molecular weight products aimed at C9+. An additional external heat exchanger 1737 (E-102), may be applied between the products of bed 4 and the naphtha feedstocks to preheat the feedstock, thus reducing furnace duty.

The reaction product of reactor 1, leaves the reactor by output line 1518-1, and is primarily composed of alkyl-aromatics with some C1-C5 hydrocarbons, then enters the stabilizing column 1730 (C-101) via infeed line 1718 to separate the gas phase products and redirect the residual fractions to specific units. According to one of the implementations, the feed for C-101 is sourced from different or both reactor 1 1703 (R-101) and reactor 2 (R-102) via line 1727. Additionally, the system can be configured to be sourced from different beds of either of the reactors by using blank trays installed within these reactors. The reflux of the stabilizing column is managed by condenser 1735 (E-103), reflux vessel 1736 (V-102), and reflux pump P-102. Fuel gas, including hydrogen, C1-C2 hydrocarbons, and carbon monoxide and dioxide, is withdrawn from processing. The C3-C5 fraction from the reflux vessel is either redirected back to the column 1730 as reflux or feed into Stage 2 1702, reactor 1704 (R-102). The C6-C8 flow is either directed back to reactor 1 1703 (R-101) for further alkylation (as part of the SAF maximizing pathway) via line 1719 and pump P-103 or withdrawn as a gasoline/BTX slipstream (as part of the gasoline/BTX production pathway). The C9 flow is optionally withdrawn from column 1720 C-101 via line 1731 by pump P-104 to adjust the composition of the finished SAF product in gas/liquid separator 1746 (V-103). The residual C9+ flow is directed via line 1732 to hydrogenation reactor 1740 (R-103) by pump P-105.

According to one of the implementations, the boiler of stabilizer column 1730 (C-101) utilizes products from reactor 1793 (R-101) and reactor 1704 (R-102) to heat the column.

Stage 2, 1702, reactor 1704 (R-102) is used to upgrade the C3-C5 fraction into C6-C8 aromatics, which are either used as Stage 1 feedstock (as part of the SAF maximizing pathway (via line 1719)) or withdrawn as a C6-C8 slipstream. Reactor 1704 (R-102) operates similarly to the Stage 1, reactor 1704, featuring a multi-bed structure. (As used herein the term bed a reactor is the same as a shelf in a reactor.) This multi-bed construction is designed to control the LHSV at each catalyst bed and the amount of ethylene fed into each catalyst layer. The basic implementation incorporates three beds operating under the following conditions:

Reactor pressure for reactor 1704: 20-40 bar g, Overall LHSV: 1 h¹, Temperatures of reactor: Bed 1, 2, 3-450-550° C. Reactor 1704 (R-102) is equipped with heat exchange devices, the specific designation of which (whether cooling or heating) depends on the exact feed composition.

According to this basic implementation, the heat exchange device is a cooling coil supplied with a cooling agent 1708, 1715, 1725. Another implementation involves using one of the process flows (feed/semi-product) as a heat exchange agent. Distribution of the reactor 2 1704 (R-102) catalyst into the beds provides a higher yield of aromatization reactions, resulting from staged ethylene introduction along the length of the reactor. Along with aromatization reactions, alkylation of the produced aromatics occurs, yielding heavy components in the C9+ range. The product from reactor 2 1704 (R-102) is sent to the stabilizing column 1730 (C-101) via lines 1727, 1718 for separation into gas, recycle, and product flows.

The fixed bed hydrogenation reactor 1740 (R-103) is fed with a C9+ stream via lines 1732, 1731 from the stabilizing column 1720 (C-101) for the hydrogenation and hydropolishing of jet fuel range hydrocarbons. Hydrogen can be supplied as an individual feed flow or separated from the fuel gas flow. Hydrogenation occurs at a temperature of 60-300° C., with a pressure of 10-100 Bar (g) and an LHSV of 0.5-3 h-1, depending on the applied catalyst. Adjusting the LHSV and hydrogen flow rate achieves a residual aromatics content of 10-20 wt. %. Unreacted hydrogen and the finished SAF product are separated in the gas/liquid separator 1756 (V-103). In one implementation, the hydrogen used for hydrogenation consists of a make-up flow mixed with hydrogen produced by the reaction process. In another implementation, the stabilizing column 1720 (C-101) produces a side flow mainly composed of C9 components mixed with some hydrocarbons of other carbon numbers, which is sent directly to the product pool, bypassing hydrogenation reactor 1740 (R-103). This measure has been found to improve the flash point of SAF by preventing the generation of C9 naphthenes and enhancing the operation of the hydrogenation unit. In yet another implementation, two columns are used instead of stabilizing column 1720 (C-101). One serves to distill gas from the unstable product, while the other separates the C6-C8 flow for recycling purposes from the product of the target heavier component.

### Example 13

Turning to FIG. 17, there is shown a schematic of a general embodiment of a system and process 1600, for making SAF and other high value hydrocarbons, including renewable hydrocarbons. The general process conditions and description of the other examples, (e.g., Examples 1, 2, 4, 11, 12, 13) can be utilized in this Example.

The joint oligomerization and aromatization processes of this Example provides a way of sustainable alcohol processing that produces “drop-In” quality SAF with required concentrations of aromatics, paraffins (either normal, iso, or cycloparaffins), and olefins.

Ethanol is introduced into a fixed bed reactor 1602 with a dehydration catalyst based on alumina oxide. Resulted products (Ethylene and Water) are further separated. The dehydration reaction occurs at 200-300° C. temperature with LHSV of 1 h-1. Although low to atmospheric pressure favors the dehydration reaction, the process could also be performed at elevated pressures, which matches and even overlaps the pressure of other process stages. Ethanol conversion remains almost complete at 99% throughout 1-50 bar(g) pressure ranges. Such flexibility, preferably, allows for the avoidance of using downstream gas compressors and feed the resulting ethylene by means of gas flow controllers.

The dehydration stage 1601 serves as the “feed hub” for four other processing stages or blocks:
Ethylene aromatization (stage 1A) 1603
Ethylene oligomerization (stage 1B) 1604
C3-C5 conversion to AC6-AC8 (stage 2) 1605
Alkylation of AC6-AC8 (stage 3) 1620.

In the aromatization stage 1604, ethylene from the dehydration stage is first oligomerized into longer-chain hydrocarbon olefins (hexene and above) and then dehydrocyclization into C9+ aromatics species in the fixed bed reactor. This stage produces a liquid product (which contains 90%+ of aromatics) and a liquid part, which is mostly built up from propane and butane but also contains some fuel gas components (hydrogen, ethane, carbon mono- and di-oxides). The process is typically conducted at temperature of 380C, pressure of 30-50 bar and LHSV of 1-1.2 h⁻¹.

In the oligomerization stage 1603, ethylene is converted into straight-chain C10+ olefins (decene, dodecane, etc.) in the multi-shelf fixed bed reactor, allowing control of the ongoing exothermic reaction's temperature profile. Unlike the aromatization block, this stage is conducted under lower temperatures (200-300° C.) and higher LHSV (3-5 h-1) in order to limit the reaction pathway to the oligomerization step only and prevent the formation of aromatic species. Due to the low process temperature, catalytic and thermal cracking reactions are suppressed, leading to a high yield of jet fuel range olefins.

Using the fractionation column 1610, C3-C5 by-products from aromatization 1604 and oligomerization 1603 stages are separated and then sent to the additional processing in stage 2 1605, which converts them into aromatic species of C6-C8 (benzene, toluene, xylenes, and ethylbenzene) in the fixed bed reactor. Process yield is controlled by the recycle ratio, where C3-C5 by-products are recycled near extinction. The process is conducted under the temperature of 520° C., LHSV of 1-1.2 h-1, and C3-C5 to Ethylene ratio of 70:30+50:50 wt. %. As with the oligomerization step, process temperature is controlled utilizing multi-shelf Ethylene injection and interstage coolers to prevent overheating catalyst bed.

The C6-C8 aromatic species from stage 2 1605 are further alkylated with ethylene to produce C9+ aromatics. The process is done in a fixed bed reactor at 380° C., LHSV of 1-1.2 h-1, and an ethylene to BTX ratio of 20:80 wt. %. Due to a low ethylene treatment rate and the presence of BTX in the feed, the reaction proceeds more selectively towards the alkylation of existing aromatics rather than producing new aromatic species.

A gasoline BTX slip stream 1621 is optional.

Hydrocarbon products obtained from four of the above-described stages are fed into hydrogenator 1609 and hydrotreated and converted to saturated hydrocarbon fuel of jet range; preferably a drop-in SAF.

### Example 14

An SAF produced from any of the systems and processes of the examples having at least 8% aromatics.

In a preferred embodiments the SAF has at least 8% aromatics and has less than 25% aromatics.

In a more preferred embodiment of the above SAFs, the SAF is drop-in ready and can be used as aviation fuel without the need, and without blending, with conventional jet fuel.

It should be further noted that these SAFs are produced from the systems and processes of the examples without combining the SAF stream with conventional aviation fuel, e.g., with a stream of conventional aviation fuel. Thus, these systems produce an isolated SAF having not been blended with or combined with conventional aviation fuel.

### Example 15

An SAF produced from any of the systems and processes of the examples having 8%-25% aromatics.

In a preferred embodiments the SAF has 8%-25% aromatics and has 10-50% paraffins.

In a more preferred embodiment of the above SAFs, the SAF is drop-in ready and can be used as aviation fuel without the need to blend with, and without blending with, conventional jet fuel.

It should be further noted that these SAFs are produced from the systems and processes of the examples without combining the SAF stream with conventional aviation fuel, e.g., with a stream of conventional aviation fuel. Thus, these systems produce an isolated SAF having not been blended with or combined with conventional aviation fuel.

### Example 16

A modular system and processes for assembly and use at a feed stock location. The system can be mounted in containers, skids, trucks, rail cars, or barges. The system is transported to feed stock location, or a location near several feed stocks, transit lines, or both, and is assembled at that location. The system's reactor operates at 380-550 C and 10 atm in an all gas-phase process across a reactor with multiple catalyst beds. For example, a standard ZSM 5 catalyst with customized active sites and treatment for durability in the presence of water. No compression or refrigeration is needed unless the hydrogenation step is needed. The systems of the examples can be configured as these modular systems.

### Example 17

A bolt-on or retrofit system and processes for assembly and use at a chemical processing plant. The system can be directly mounted on and incorporated into an existing refinery to utilize the intermediated synthetic hydrocarbons to produce SAF. The systems of the examples can be configured as these bolt-on or retrofit systems.

### Example 18

An SAF that has reduced carbon intensity (CI) when compared to conventional jet fuel. Typical conventional jet fuel has a CI of about 90 gCO2/MJ. Embodiments of the present drop-in SAF have CI of less than 60 gCO2/MJ, less than 50 gCO2/MJ, less than 40 gCO2/MJ and less than 30 gCO2/MJ and can be less than 0 gCO2/MJ depending on the CI of the feedstocks as described above. Preferably this drop-SAF has a blend limit of greater than 50% and more preferably has no blend limit. These SAFs can be produced from the systems and process of the examples.

### Example 19

An SAF that has reduced carbon intensity (CI) by only having a slight increase in the CI of its feed stock. An embodiment of the SAF has a CI that is only 25% greater than the CI of the feed stock used to produce the SAF. An embodiment of the SAF has a CI that is only 20% greater than the CI of the feed stock used to produce the SAF. An embodiment of the SAF has a CI that is only 15% greater than the CI of the feed stock used to produce the SAF. An embodiment of the SAF has a CI that is only 10% greater than the CI of the feed stock used to produce the SAF. These SAFs can be produced from the systems and process of the examples.

### Example 20

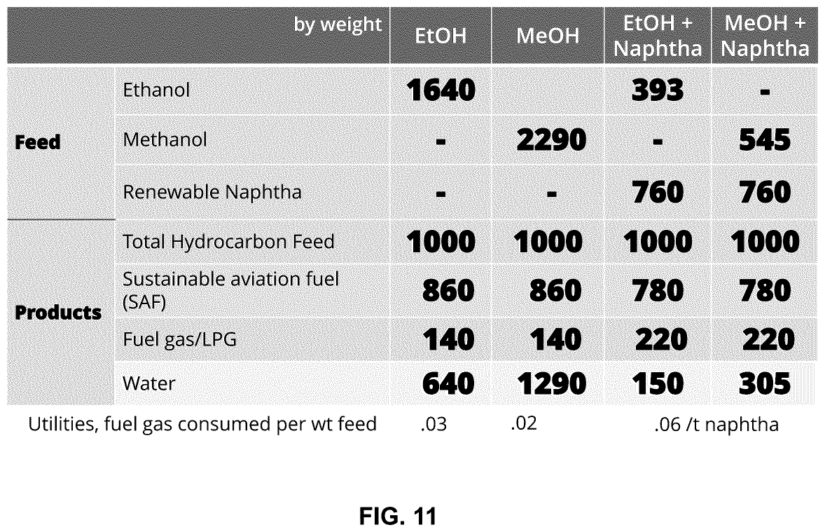

Turning to FIG. 11 there is table setting forth an embodiment of a material balance of the present systems and methods. This material balance can be used or form a part of the processes of the examples.

### Example 21

Turning to FIG. 12 there is table setting forth an embodiment of a material balance of the present systems and methods. This material balance can be used or form a part of the processes of the examples.

### Example 22

One or more of the infeed starting materials of the examples is a green crude, or other such materials that are typically obtained from hydrothermal liquefaction.

### Example 23

A system and process have two sub-processes: 1) non-aromatic via dehydration, oligomerization, hydrogenation, and fractionation—e.g., stage 1, and 2) aromatic via dehydration, aromatization, hydrogenation, and fractionation—e.g., stage 2.

The two subprocesses each including oligomerization and aromatization leading to the same hydrogenation, can provide hydrogenation of the aromatic subprocess, and oligomerization in non-aromatic only and aromatization in aromatic only.

In an embodiment, fractionate stage 1 separate from stage 2 with resultant C9+ separately; hydrogenated: stage 2 lightly to leave aromatics and stage 1 severely to be considered “non-aromatic”.

An embodiment of a finished blend can preferably have <40 wt % cycloparaffins and <21.2 wt % aromatics. Thus, to provide this embodiment of a blend, stage 1 hydrogenation to reduce cycloparaffins from 86% to <35% (to allow for some cycloparaffins in the stage 2 C9+).

An embodiment of a finished blend from synthetic blending components has hydroprocessed synthesized paraffinic kerosene with aromatics wholly derived from any single C2 to C5 alcohol or combination of two or more C2 to C5 alcohols and composed of the streams of two subprocesses processed through the following steps: A non-aromatic product stream comprising dehydration, oligomerization, hydrogenation, and fractionation, and an aromatic product stream comprising dehydration, aromatization, hydrogenation, and fractionation.

### Example 24

The systems and processes of the forgoing Examples can be used to product a jet fuel having the composition ranges set forth in Table 1.

TABLE 1

| Hydrocarbon Group | Typical Range (% mass) |
|---|---|
| Paraffins | 30-40 |
| Iso-paraffins | 25-35 |
| Naphthenes | 10-20 |
| Aromatics | 10-15 |

The jet fuel can be a SAF, a renewable jet fuel and a drop-in SAF.

### Headings and Embodiments

It should be understood that the use of headings in this specification is for the purpose of clarity, reference, and is not limiting in any way. Thus, the processes compositions, and disclosures described under a heading should be read in context with the entirely of this specification, including the various Examples. The use of headings in this specification should not limit the scope of protection afforded the present inventions.

It is noted that there is no requirement to provide or address the theory underlying the novel and groundbreaking production rates, performance or other beneficial features and properties that are the subject of, or associated with, embodiments of the present inventions. Nevertheless, various theories are provided in this specification to further advance the art in this important area, and in particular in the important area of renewable hydrocarbons, and hydrocarbon processing and production. These theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the, reactions, materials, methods, and systems of the present inventions; and such later developed theories shall not limit the scope of protection afforded the present inventions.

The various embodiments of materials, reactions, devices, systems, activities, methods and operations set forth in this specification may be used with, in or by, various processes, industries and operations, in addition to those embodiments of the Figures and disclosed in this specification. The various embodiments of materials, reactions, devices, systems, methods, activities, and operations set forth in this specification may be used with: other processes industries and operations that may be developed in the future: with existing processes industries and operations, which may be modified, in-part, based on the teachings of this specification; and with other types of systems and methods. Further, the various embodiments of devices, systems, activities, methods and operations set forth in this specification may be used with each other in different and various combinations. Thus, for example, the configurations provided in the various embodiments of this specification may be used with each other. For example, the components of an embodiment having A, A′ and B and the components of an embodiment having A″, C and D can be used with each other in various combination, e.g., A, C, D, and A. A″ C and D, etc., in accordance with the teaching of this specification. Thus, the scope of protection afforded the present inventions should not be limited to a particular embodiment, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

1. A system for producing a sustainable aviation fuel (SAF), the SAF comprising naphthenes and aromatics, the system comprising:
a. a first reactor; and a second reactor;
b. the first reactor comprising a first reactor first bed, a first reactor second bed and a first reactor third bed; wherein the first reactor beds are configured such that material flow is from the first bed to the second bed and then to the third bed;
c. the first reactor first bed comprising an infeed line that provides a starting material comprising an alcohol, an ether, or a mixture of both, to the first reactor first bed;
d. the first reactor second bed in fluid communication with a hydrocarbon source, wherein the hydrocarbon comprises an alkene;
e. the first reactor having a first reactor output line and configured to provide a first reactor product from the first reactor output line;
f. the second reactor comprising three reactor beds; wherein the second reactor beds are configured such that material flow is from a second reactor first bed, to a second reactor second bed, and then to a second reactor third bed;
g. the second reactor first bed comprising a second reactor infeed line that is in fluid communication with the first reactor output line; whereby the second reactor first bed is configured to receive at least some of the first reactor product;
h. the second reactor having a second reactor output line and configured to provide a second reactor product from the second reactor output line; and,
i. the system configured to provide one or more final products from the second reactor product, whereby at least one of the final products is an SAF comprising naphthenes and at least 3 weight % aromatics.

2. The system of claim 1, further comprising:
a. the first reactor further comprising a first reactor fourth bed; wherein the first reactor beds are configured such that material flow is from the third bed to the fourth bed and wherein the fourth bed comprises the first reactor output line;
b. a first reactor first bed outlet line, wherein the outlet line is in fluid communication with a first separator, whereby at least some of a first reactor first bed product is provided to the first separator; and wherein the first separator is configured to separate water from the first reactor first bed product and return a dewatered first reactor first bed product to one or more of the first reactor second bed, the first reactor third bed, and the first reactor fourth bed;
c. the first reactor output line is in fluid communication with a stabilizing column, whereby the first reactor product is provided to the stabilizing column; the stabilizing column is configured to separate the first reactor product into at least two portions, a first portion comprising Cn hydrocarbons and a second portion comprising Cn′ hydrocarbons;
d. the second reactor configured to receive the first portion of the first reactor product; whereby at least some of the first portion of the first reactor product is provided to the second reactor first bed; and,
e. whereby the second reactor output line is in fluid communication with the stabilizer, whereby the second reactor product is provided to the stabilizing column.

3. The system of claim 2, further comprising:
a. a hydrogenation reactor;
b. a gas liquid separator;
c. wherein the second portion comprising Cn′ hydrocarbons is provided to the hydrogenation reactor and the gas liquid separator;
d. wherein an output from the hydrogenation reactor is provided to the gas liquid separator;
e. whereby the gas liquid separator is configured to provide the SAF.

4. The system of claim 3, wherein the dewatered first reactor first bed product is provided to the second reactor.

5. The system of claim 1, wherein the hydrocarbon source is the first reactor first bed.

6. The system of claim 2, wherein the hydrocarbon source is the first reactor first bed product, the dewatered first reactor first bed product or both.

7. The system of claim 1, wherein the starting material comprises a C1 to C4 alcohol.

8. The system of claim 1, wherein the starting material consists essential of ethanol.

9. (canceled)

10. The system of claim 1, wherein there are no addition points for the addition of conventional hydrocarbons.

11. The system of claim 1, wherein n is 3-5 in the first portion Cn hydrocarbons, whereby the hydrocarbons in the first portion comprises hydrocarbons having a carbon number of C3-C5; and wherein n′ is 9+, whereby the Cn′ hydrocarbons in the second portion have a carbon number of C9+.

12. The system of claim 1, wherein the alkene is ethylene.

13. The system of claim 1, wherein the SAF comprises at least 8 weight % aromatics.

14. The system of claim 1, wherein the SAF comprises 5% to about 25 weight % aromatics.

15. The system of claim 1, wherein the SAF comprises paraffins, and the amount of the paraffins is less than 50 weight %.

16. The system of claim 1, wherein the SAF comprises at least 8 weight % aromatics, paraffins and the amount of the paraffins is less than 50 weight % paraffins by weight.

17. The system of claim 1, wherein the SAF comprises paraffins and 30% to 90% naphthene.

18. The system of claim 1, wherein the SAF has a carbon intensity (CI) of about 60 g/MJ or less.

19. (canceled)

20. A method of producing a sustainable aviation fuel (SAF), the SAF comprising naphthenes and aromatics, the method comprising:
a. providing an infeed stock to a reactor, the infeed stock consisting essentially of a first component that is a synthesized hydrocarbon and a second component that is an alcohol, an ether or both;
b. conducting a catalytic reaction on the infeed stock, to thereby provide a first intermediate hydrocarbon product;
c. conducting a catalytic reaction on the first intermediate hydrocarbon product to thereby provide a second intermediate hydrocarbon product; and,
d. hydrogenating at least some of the second intermediate hydrocarbon product;
e. thereby providing an SAF comprising a paraffin and at least 3 weight % aromatics.

21. (canceled)

22. (canceled)

23. (canceled)

24. The method of claim 20, wherein the synthesized hydrocarbon is a renewable naphtha.

25-40. (canceled)
